(19) United States
(12) Patent Application Publication
(10) Pub. No.: US 2007/0198659 A1
(43) Pub. Date: Aug. 23, 2007

(54) Method and system for storing data

(76) Inventor: Wai T. Lam, Jericho, NY (US)

Correspondence Address: BRANDON N. SKLAR. ESQ. (PATENT PROSECUTION);KAYE SCHOLER, LLP, 425 PARK AVENUE, NEW YORK, NY, 10022-3598, US

(21) Appl. No.: 11/657,283

(22) Filed: Jan. 24, 2007

Related U.S. Application Data
(60) Provisional application No. 60/762,058, filed on Jan. 25, 2006.

(51) Int. Cl. G06F 15/16

(52) U.S. Cl. 709/219

(57) ABSTRACT

In an example of an embodiment of the invention, a data set is stored in a database, at a first moment in time, at least first and second segments of data within the data set are defined, and a portion of a selected one of the at least two segments is stored in association with the database. A location of a third segment of data is identified within the data set, at a second moment in time subsequent to the first moment, based, at least in part, on the portion. In one example, a determination is made whether the selected segment has been altered between the first and second moments in time, by generating a second digest representing the third segment, and comparing the second digest to the stored digest. A digest representing the selected segment may be generated and stored in association with the portion.

This application claims the benefit of U.S. Provisional Patent Application No. 60/762,058, which was filed on Jan. 25, 2006 and is incorporated by reference herein.

### FIELD OF THE INVENTION

The invention relates generally to methods and systems for storing data, and more particularly, to methods and systems for backing up data stored in a communication system.

### BACKGROUND OF THE INVENTION

In many computing environments, large amounts of data are written to and retrieved from storage devices connected to one or more computers. For example, many large organizations maintain local area networks (LANs) comprising multiple personal computers (PCs) which are used on a daily basis by employees. Typically, the employees regularly store data on the local disk drives within the PCs. As the amount of data stored on such local disk drives increases, the aggregate value of that data to the organization also increases. Consequently, it is a common practice to back up locally stored data by storing copies of the data on one or more remote, backup storage devices.

One well-known approach to backing up data is periodically to generate a copy of data stored on a local storage device and transmit the copy to a remote backup storage device. For example, in a large organization such as that described above, data stored on one or more PCs in the network may be copied and transmitted via the network to a dedicated storage device located elsewhere on the network (or located outside the network). The copied data is often encrypted and/or compressed prior to being transmitted to the dedicated storage device. This procedure may be performed once per day, for example, or at any other specified interval. The backup procedure is ordinarily performed by a software application residing on a network server, in a manner that is transparent to users. The interval at which data is backed up is typically specified by a system administrator based on time, cost, and security considerations.

Existing backup software applications typically encrypt and/or compress files on a file-level basis. During an initial backup, selected files in a local storage device are encrypted and/or compressed (in their entirety), and transmitted to a backup storage device, where they are stored. Because the encryption/compression is performed on a file-by-file basis, it is also necessary to perform each subsequent backup on a file-level basis. The backup application identifies a file in the local storage device that has been changed since the previous backup procedure and generates a copy of the file. The copied file is again encrypted and/or compressed (in its entirety) and transmitted to the backup storage device, where it is stored as a newer version of the file. Multiple versions of a file are therefore available for later retrieval, in case the local storage device fails and a user wishes to restore one or more of the versions.

### SUMMARY

In an example of an embodiment of the invention, a method of backing up data is provided. The method comprises storing a data set in a database, at a first moment in time, defining at least first and second segments of data within the data set, and storing, in association with the database, a portion of a selected one of the at least two segments. The method also comprises identifying a location of a third segment of data within the data set, at a second moment in time subsequent to the first moment, based, at least in part, on the portion.

In one example, the method further comprises determining whether the selected segment has been altered between the first and second moments in time. The method may also comprise generating a digest representing the selected segment and storing the digest in association with the portion. The determination as to whether the selected segment has been altered may be made by generating a second digest representing the third segment, comparing the second digest to the stored digest, and determining that the selected segment has been altered, if the second digest and the stored digest are not the same.

In one example, the portion comprises a predetermined quantity of data selected from a corresponding segment. For example, the portion may comprises eight bytes of data selected from the corresponding segment. The eight bytes are selected from a beginning of the corresponding segment.

The digest may comprise a hash value. The hash value may be generated using a message digest 5 algorithm, a secure hash algorithm, etc.

In another example, the method also comprises storing, in the database, a second portion retrieved from the third segment and a digest representing the third segment; if the selected segment has been altered. Additionally, the method may comprise storing, in a second database, the second portion of the third segment and the second digest representing the third segment; if the selected segment has been altered. An identifier of the third segment may be stored in the second database.

In one example, the location of the third segment within the data set is identified, at the second moment in time subsequent to the first moment, by searching within the data set for the portion, starting at a beginning of the data set, or alternatively, at an end of the data set.

In another example of an embodiment of the invention, a method for backing up data is provided. The method comprises storing a data set in a database, at a first moment in time, defining at least two segments of data in the data set, and storing, in association with the first database, at least one digest representing a selected one of the at least two segments. The method also comprises retrieving, at a second moment in time subsequent to the first moment in time, the at least one digest, and determining whether a the selected segment has been altered since the first moment in time, based at least in part on the retrieved digest. The digest may comprise a hash value.

The determination as to whether the selected segment has been altered since the first moment in time may be made by identifying a second segment from the data set, generating a second digest based on the second segment, comparing the second digest to the first digest, and determining that the selected segment has been altered, if the second digest and the first digest are not the same. The second digest may comprise a second hash value.

The selected segment may be stored in a second database. The method may further comprise storing the selected segment in a first location in the second database, and storing the second segment in a second location in the second database.

In another example, the method may also comprise storing, in association with the first database, a portion representing a third segment selected from among the at least two segments, and identifying a location of a fourth segment within the data set, at a third moment in time subsequent to the first moment in time, based on the portion.

In another example of an embodiment of the invention, a method for storing data is provided. The method comprises storing a first version of a data file in a first database and in a second database, defining at least two first segments within the first version, storing a second version of the data file in the first database, and determining whether the second version contains all of the at least two first segments. The method also comprises defining one or more second segments within the second version different from any of the at least two first segments, if the second version does not contain all of the at least two first segments, and storing the one or more second segments in the second database.

The method may further comprise defining one or more additional segments within the second version, if the second version does contain all of the at least two first segments, and storing the one or more additional segments in the second database. The method may also comprise storing, in association with the first database, digests representing the respective first segments, and determining whether the second version contains all of the at least two first segments, based, at least in part, on the digests.

In another example, the method additionally comprises storing, in association with the first database, portions of respective first segments, and defining the one or more second segments within the second version, based, at least in part, on the portions. The method may further comprises storing, in association with the first database, digests representing the one or more second segments.

In another example of an embodiment of the invention, a system to back up data is provided. The system comprises a memory configured to store a database comprising one or more data sets. The system also comprises a processor configured to store a data set in the database, at a first moment in time, define at least first and second segments of data within the data set, and store, in association with the database, a portion of a selected one of the at least two segments. The processor is also configured to identify a location of a third segment of data within the data set, at a second moment in time subsequent to the first moment, based, at least in part, on the portion.

In one example, the processor is further configured to determine whether the selected segment has been altered between the first and second moments in time. The processor may also be configured to generate a digest representing the selected segment, and store the digest in association with the portion. The processor may be further configured to determine whether the selected segment has been altered by generating a second digest representing the third segment, comparing the second digest to the stored digest, and determining that the selected segment has been altered, if the second digest and the stored digest are not the same.

In another example of an embodiment of the invention, a system to back up data is provided. The system comprises a memory configured to store a database comprising one or more data sets. The system also comprises a processor configured to store a data set in the database, at a first moment in time, define at least two segments of data in the data set, and store, in association with the first database, at least one digest representing a selected one of the at least two segments. The processor is also configured to retrieve, at a second moment in time subsequent to the first moment in time, the at least one digest, and determine whether a the selected segment has been altered since the first moment in time, based at least in part on the retrieved digest.

In one example, the processor is further configured to determine whether the selected segment has been altered since the first moment in time by identifying a second segment from the data set, generating a second digest based on the second segment, comparing the second digest to the first digest, and determining that the selected segment has been altered, if the second digest and the first digest are not the same.

The system may additionally comprise a second processor configured to store the selected segment in a second database. In one example, the second processor is further configured to store the second segment in the second database, if the selected segment has been altered. The second processor may further configured to store the selected segment in a first location in the second database, and store the second segment in a second location in the second database.

In another example, the processor is further configured to store, in association with the first database, a portion representing a third segment selected from among the at least two segments, and identify a location of a fourth segment within the data set, at a third moment in time subsequent to the first moment in time, based on the portion.

In another example of an embodiment of the invention, a system to store data is provided. The system comprises a memory configured to store a database comprising one or more data sets. The system also comprises a first processor configured to store a first version of a data file in a first database, and a second processor configured to store the first version of the data set in a second database. The first processor is further configured to define at least two first segments within the first version, store a second version of the data file in the first database, determine whether the second version contains all of the at least two first segments, and define one or more second segments within the second version different from any of the at least two first segments, if the second version does not contain all of the at least two first segments. The second processor is further configured to store the one or more second segments in the second database.

In one example, the first processor is further configured to define one or more additional segments within the second version, if the second version does contain all of the at least two first segments, and the second processor is further configured to store the one or more additional segments in the second database.

In another example, the first processor is further configured to store, in association with the first database, digests representing the respective first segments, and determine whether the second version contains all of the at least two first segments, based, at least in part, on the digests. The first processor may be further configured to store, in association with the first database, portions of respective first segments, and define the one or more second segments within the second version, based, at least in part, on the portions. Digests representing the one or more second segments may be stored in association with the first database.

### BRIEF DESCRIPTION OF THE DRAWINGS

These and other features and advantages of the invention will be apparent to those skilled in the art from the following detailed description of preferred embodiments, taken together with the accompanying drawings, in which:

FIG. 1 shows an example of a system that may be used to store data, in accordance with an embodiment of the invention;

FIG. 2 shows examples of several components of a client, in accordance with an embodiment of the invention;

FIG. 3 shows an example of a folder, in accordance with an embodiment of the invention;

FIG. 4 shows examples of components of a backup server, in accordance with an embodiment of the invention;

FIG. 5 shows an example of a graphical user interface (GUI), in accordance with an embodiment of the invention;

FIG. 6 is a flowchart depicting a routine to back up a data set, in accordance with an embodiment of the invention;

FIG. 7 shows an example of a file divided into file segments, in accordance with an embodiment of the invention;

FIG. 8 shows a current version database, in accordance with an embodiment of the invention;

FIG. 9 shows an example of a file object database, in accordance with an embodiment of the invention;

FIG. 10 shows an example of a file object, in accordance with an embodiment of the invention;

FIG. 11 shows an example of a file divided into file segments, in accordance with an embodiment of the invention;

FIG. 12A is a flowchart depicting a method to identify previously-defined segments in a data set, in accordance with an embodiment of the invention;

FIG. 12B is a flowchart depicting a method to back up a data set, in accordance with an embodiment of the invention;

FIG. 13 shows an example of a current version database, in accordance with an embodiment of the invention;

FIG. 14 shows an example of a file object, in accordance with an embodiment of the invention;

FIG. 15 shows an example of a file divided into file segments, in accordance with an embodiment of the invention;

FIG. 16 is a flowchart depicting an alternative method to identify previously-defined segments in a data set, in accordance with an embodiment of the invention;

FIG. 17 shows an example of a file divided into file segments, in accordance with an embodiment of the invention;

FIG. 18 shows an example of a file divided into file segments, in accordance with an embodiment of the invention;

FIG. 19 shows an example of a current version database, in accordance with an embodiment of the invention;

FIG. 20 shows an example of a file divided into file segments, in accordance with an embodiment of the invention;

FIG. 21 shows an example of a file divided into file segments, in accordance with an embodiment of the invention;

FIG. 22 is a flowchart depicting another alternative method to identify previously-defined segments in a data set, in accordance with an embodiment of the invention;

FIG. 23 shows an example of a file divided into file segments, in accordance with an embodiment of the invention;

FIG. 24 shows an example of a current version database, in accordance with an embodiment of the invention;

FIG. 25 shows an example of a file object, in accordance with an embodiment of the invention;

FIG. 26 shows an example of a file divided into file segments, in accordance with an embodiment of the invention;

FIG. 27 shows an example of a file divided into file segments, in accordance with an embodiment of the invention;

FIG. 28 shows an example of a file divided into file segments, in accordance with an embodiment of the invention;

FIG. 29 shows an example of a current version database, in accordance with an embodiment of the invention;

FIG. 30 shows an example of a file object, in accordance with an embodiment of the invention;

FIG. 31 is a flowchart depicting a method to restore a data set, in accordance with an embodiment of the invention; and

FIG. 32 shows an example of an alternative system that may be used to store data, in accordance with an embodiment of the invention.

### DETAILED DESCRIPTION OF THE PREFERRED EMBODIMENTS

In accordance with an example of an embodiment of the invention, a method and system are provided for backing up a data set. During a first backup procedure, a data set selected to be backed up is retrieved from a first storage device. The data set may comprise a file, for example; however, a data set may alternatively comprise multiple files, one or more folders, or any other data structure. One or more file segments are defined within the file, and copies of the file segments are transmitted to a backup storage device, where they are stored. One or more message digests corresponding to the respective file segments are generated and stored in a current version database in the first storage device. A message digest is a value that represents a file segment or other data block. During a subsequent backup procedure, the file is retrieved from the storage, and a one or more second file segments are defined within the file. One or more second message digests corresponding to the respective second file segments are generated, and compared to the corresponding stored message digests. To update the data stored in the backup storage device, only those second file segments for which a corresponding second message digest does not match a corresponding stored message digest are copied to the backup storage device. To update the current version database, only those second message digests for which no corresponding stored message digest is found are stored.

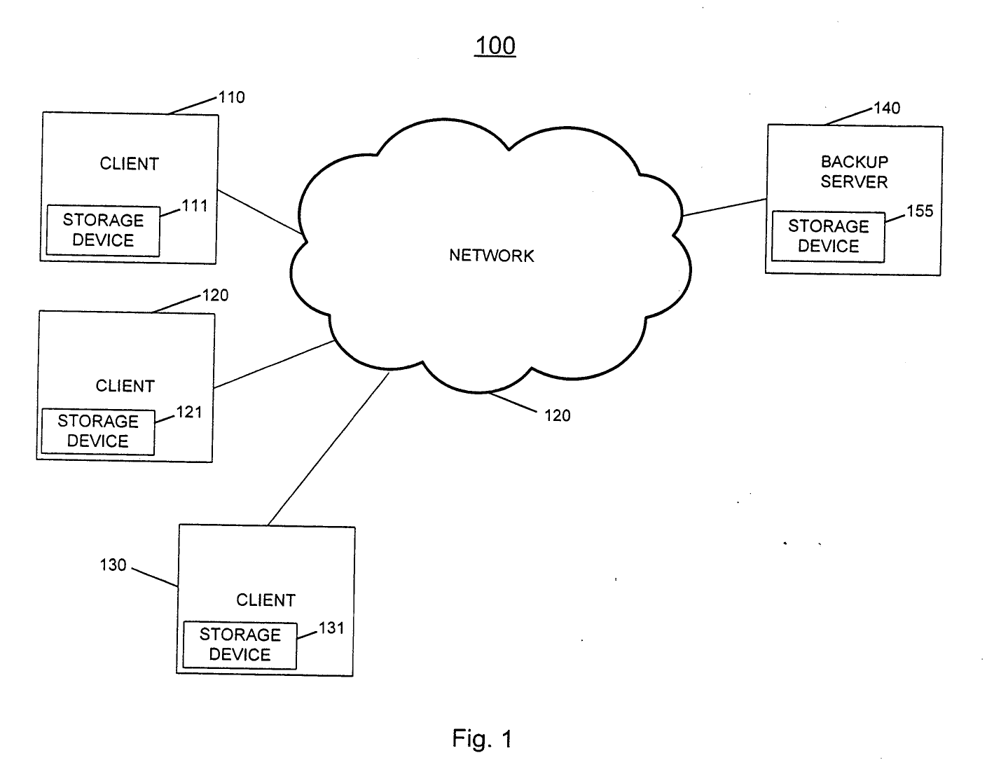

FIG. 1 is a block diagram of an example of a system 100 that may be used to store data, in accordance with an embodiment of the invention. The system 100 comprises one or more clients, a network 120, and a backup server 140. In the example shown in FIG. 1, the system 100 comprises three clients 110, 120, and 130. However, any number of clients may be included in system 100.

Each of the clients 110, 120, and 130 manages data that is generated and/or stored locally, and transmits the data via the network 120 to the backup server 140 for the purpose of backing up the data. Each of the clients 110, 120, 130 may comprise hardware, software, or a combination of hardware and software. For the purpose of storing data locally, the clients 110, 120, and 130 also comprise local storage devices 111, 121, and 131, respectively. Storage devices 111, 121, and 131 may comprise any mechanism that is capable of storing data, such as disk drives, tape drives, optical disks, etc. Alternatively, each of clients 110, 120, and 130 may have access to an external storage device on which data may be stored.

In one example, each of the clients 110, 120, and 130 may comprise one or more computers or other devices, such as one or more personal computers (PCs) servers or workstations. Alternatively, one or more of the clients 110, 120, 130 may comprise a software application residing on a computer or other device. Two or more of clients 110, 120, 130 may be distinct software applications residing on the same computer or device.

The network 120 may comprise any one of a number of different types of networks. In one example, communications are conducted over the network 120 by means of IP protocols. In another example, communications may be conducted over network 120 by means of Fibre Channel protocols. Thus, the network 120 may be, for example, an intranet, a local area network (LAN), a wide area network (WAN), an internet, Fibre Channel storage area network (SAN), or Ethernet. Alternatively, the network 120 may comprise a combination of different types of networks.

The backup server 140 receives data from the clients 110, 120 and 130, and backs up the received data. The backup server 140 may comprise hardware or software, or a combination of hardware and software. For the purpose of storing data, the backup server 140 also comprises a storage device 155. In one example, the backup server 140 comprises a computer. The storage device 155 may comprise any mechanism that is capable of storing data, such as a disk drive, tape drive, optical disk, etc. Alternatively, the backup server 140 may have access to an external storage device.

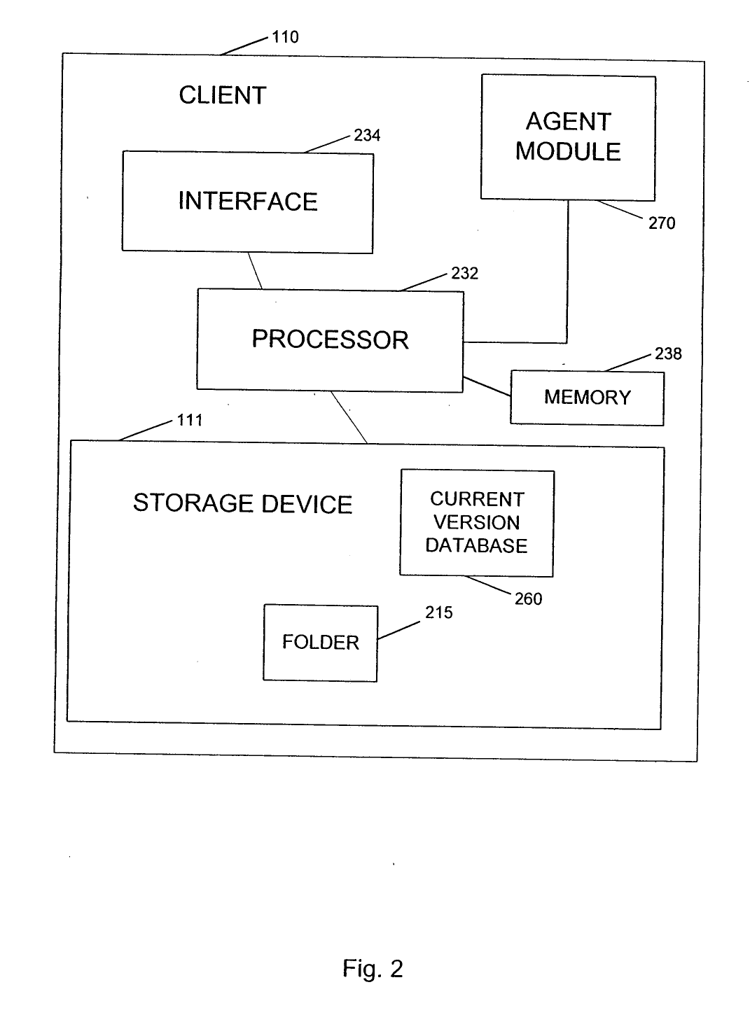

One or more of the clients, such as client 110, may comprise a computer. FIG. 2 is a block diagram of an example of the client 110. The client 110 here comprises a processor 232, an interface 234, a memory 238, a storage device 111, and an agent module 270. The processor 232 controls the operations of the client computer 110, including generating data processing requests directed to the backup server 140, and storing and retrieving data in the storage device 111. The memory 238 may comprise random-access memory (RAM). The memory 238 may be used by the processor 232 to store data on a short-term basis. The interface 234 provides a communication gateway through which data may be transmitted between the processor 232 and the network 120. The interface 234 may comprise any one or more of a number of different mechanisms, such as one or more SCSI cards, enterprise systems connection cards, fiber channel interfaces, modems, or network interfaces.

In this example, the storage device 111 comprises one or more disk drives; however, in alternative examples, the storage device 111 may comprise any other appropriate mechanism capable of storing data, such as a tape drive, optical disk, etc. The storage device 111 may perform data storage operations at a block-level or at a file-level. It should be noted that the connection between the processor 232 and the storage device 111 may comprise one or more additional interface devices.

The agent module 270 comprises a software application that resides on the client 110. The agent module 270 may from time to time retrieve and/or store data in the storage device 111. The agent module 270 also may cause data to be transmitted to the backup server 140.

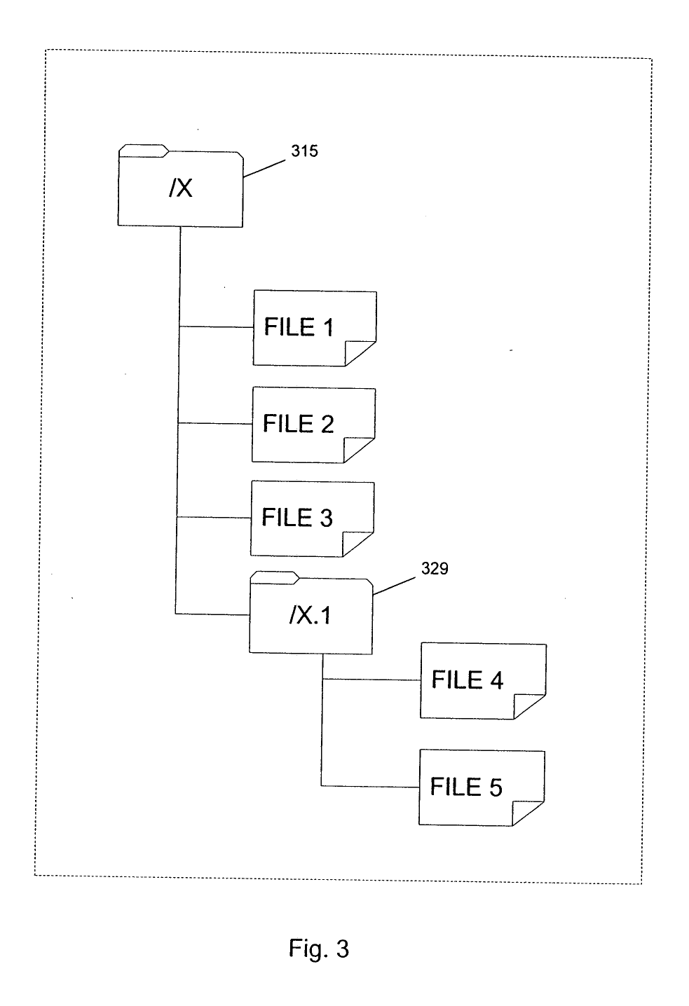

The client 110 may store data locally, for example, in the storage device 111. Data may be stored in the storage device 111 in the form of data files, which may in turn be organized and grouped into folders, such as folder 215, an example of which is shown in FIG. 3. A folder is sometimes referred to as a “directory,” and a directory within another directory is sometimes referred to as a “sub-directory.” Alternatively, data may be stored using other data structures.

Storing data in the form of data files and folders, and maintaining directories to facilitate access to such files and folders, are well-known techniques. In this example, the folder 215 is defined by the directory path “/X” (315) and comprises FILE 1, FILE 2, and FILE 3. Folder 215 also contains within itself another folder, defined by the directory path “/X.Y” (329), which in turn contains FILE 4 and FILE 5. Accordingly, each file is associated with a unique storage address specified in part by its directory path. It should be noted that the various data files stored in a folder (e.g., FILES 1, 2, 3, etc.) may be stored collectively on a single storage device, for example, a single disk drive, or alternatively may be stored collectively on multiple storage devices, such as FILE 1 on a first disk drive, FILE 2 on a second disk drive, etc.

The processor 232 additionally maintains one or more current version databases in the storage device 111 to monitor various changes that are made to the files and folders stored in the storage device 111. The structure of the current version databases is discussed in more detail below.

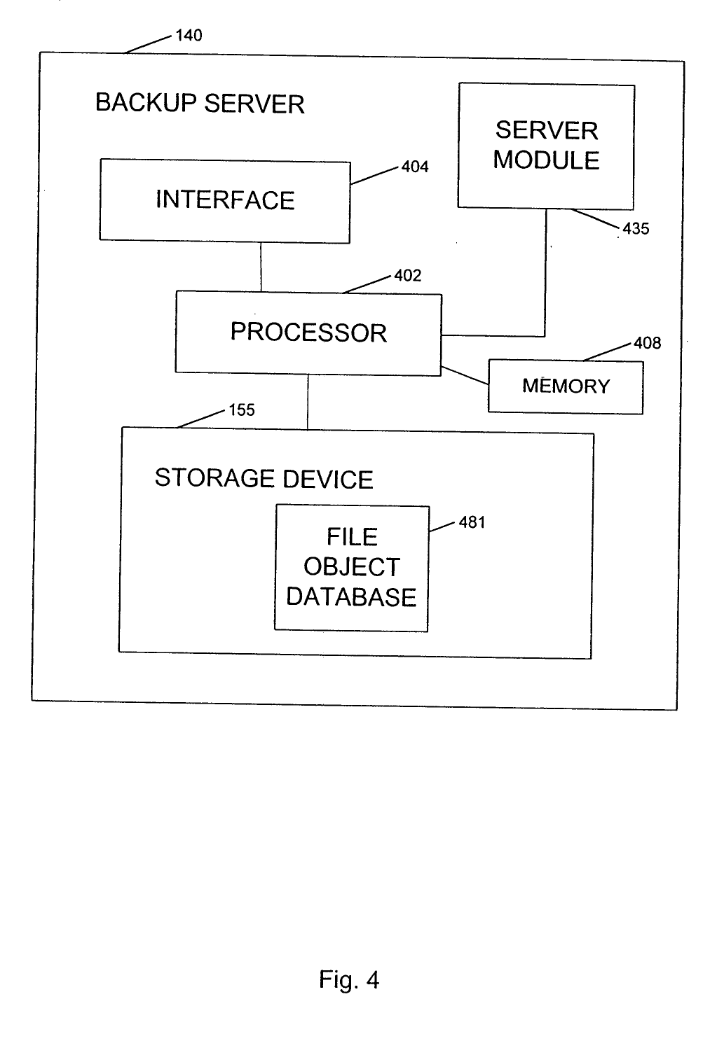

The backup server 140 receives data from various clients and causes the data to be stored in the storage device 155. FIG. 4 is a block diagram of an exemplary backup server 140 that may implement embodiments of the invention. The backup server 140 comprises a processor 402, an interface 404, a memory 408, the storage device 155, and a server module 435. The processor 402 controls the operations of the backup server 140, including storing and retrieving data from the storage device 155, storing data in, and retrieving data from, the memory 408, and causing data to be transmitted to the clients 110, 120, and 130. The memory 408 may comprise random-access memory (RAM). The memory 408 may be used by the processor 402 to store data on a short-term basis. The interface 404 provides a communication gateway through which data may be transmitted between the processor 402 and the network 120. The interface 404 may comprise any one or more of a number of different mechanisms, such as one or more SCSI cards, enterprise systems connection cards, fiber channel interfaces, modems, or network interfaces. In this example, the backup server 140 comprises a computer, such as an Intel processor-based personal computer.

In this example, the storage device 155 comprises one or more disk drives; however, in alternative examples, the storage device 155 may comprise any appropriate mechanism capable of storing data, such as tape drives, optical disks, etc. The storage device 155 may perform data storage operations at a block-level or at a file-level. It should be noted that the connection between the processor 402 and the storage device 155 may comprise one or more additional interface devices. In another alternative example, the storage device 155 may comprise a storage system separate from the backup server 140. In this case, the storage 155 may comprise one or more disk drives, tape drives, optical disks, etc., and may also comprise an intelligent component, including, for example, a processor, a storage management software application, etc.

The server module 435 from time to time receives and processes data received from the clients 110, 120, and 130. For example, the server module 435 may receive data from the agent module 270 (in client 110) and cause the data to be stored in the storage device 155. To facilitate the storage of data, the server module 435 may maintain one or more databases in the storage device 155. For example, the server module 435 may create and maintain a file object database 481 in the storage 155. The file object database 481 may be maintained in the form of a file directory structure containing files and folders. Alternatively, the file object database 481 may comprise a relational database or any other appropriate data structure. The server module 435 may comprise software, hardware, or a combination of software and hardware. In the example of FIG. 4, the server module 435 comprises a software application residing on the backup server 140.

The backup server 140 may dynamically allocate the disk space on the storage device 155 according to a technique that assigns disk space to a virtual disk drive as needed. An example of such a method for dynamically allocating disk space can be found in U.S. patent application Ser. No. 10/052,208, entitled “Dynamic Allocation of Computer Memory,” filed Jan. 17, 2002 (the “'208 Application”), which is incorporated herein by reference in its entirety. The dynamic allocation technique described in the '208 Application functions on a drive level. In such instances, disk drives that are managed by the backup server 140 are defined as virtual drives. The virtual drive system allows an algorithm to manage a “virtual” disk drive having assigned to it an amount of virtual storage that is larger than the amount of available physical storage. Accordingly, large disk drives can virtually exist on a system without requiring an initial investment of an entire storage subsystem. Additional storage may then be added as required without committing these resources prematurely. Alternatively, a virtual disk drive may have assigned to it an amount of virtual storage that is smaller than the amount of available physical storage.

According to the virtual drive system, when the backup server 140 initially defines a virtual storage device, or when additional storage is assigned to the virtual storage device, the disk space on the storage devices is divided into storage segments (not to be confused with “file segments” described below). Each storage segment has associated with it segment descriptors, which are stored in a free segment list in memory. Generally, a segment descriptor contains information defining the storage segment it represents; for example, the segment descriptor may define a home storage device location, physical starting sector of the segment, sector count within the storage segment, and storage segment number.

As storage segments are needed to store data, the next available segment descriptor is identified from the free segment list, the data is stored in the storage segment, and the segment descriptor is assigned to a new table called a storage segment map. The storage segment map maintains information representing how each storage segment defines the virtual storage device. More specifically, the storage segment map provides the logical sector to physical sector mapping of a virtual storage device. After the free segment descriptor is moved or stored in the appropriate area of the storage segment map, the storage segment is no longer a free storage segment but is now an allocated storage segment.

Agent Module: Initial Backup

In one example of an embodiment of the invention, the agent module 270 (on client 110, FIG. 2) transmits a data set to the backup server 140 for the purpose of backing up the data. The agent module 270 may transmit, for example, a data set comprising a single file, multiple files, an entire folder, or multiple folders.

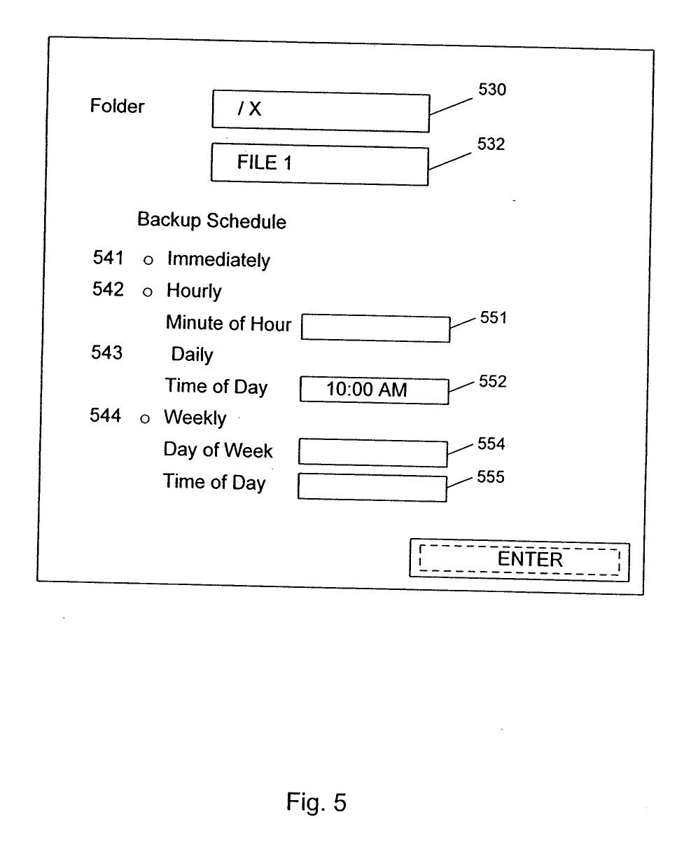

The agent module 270 may cause data to be backed up in accordance with one or more backup policies established by a user. To enable a user to establish such backup policies, the agent module 270 may make available a graphical user interface (GUI), such as that shown in FIG. 5, to a user of the client 110. Referring to FIG. 5, the GUI 557 may be accessible to a user from within a directory application such as Windows Explorer. For example, the agent server 270 may automatically display the GUI 557 on a display screen associated with the client 110 when the user at the client 110 selects, via Microsoft Explorer, a data set (which may include one or more files or folders, for example), and then presses a predetermined key on the keyboard or performs another predetermined action such as “right-clicking” on a computer mouse, and selects a desired option.

By way of example, let us suppose that a user of client 110 invokes Windows Explorer to examine various folders and files stored in the storage device 111. Suppose further that the user, wishing to back up the contents of FILE 1 in folder 215, uses a computer mouse to select FILE 1 on the screen, and then “right-clicks” on the computer mouse and selects a desired option. In response, the agent module 270 causes the GUI 557 to appear on the screen. The GUI 557 includes fields specifying a folder (field 530) and a file (field 532). Fields 530 and 532 may be completed automatically by the agent module 270 based on the file and/or folder selected by the user via Windows Explorer. Thus, fields 530 and 532 indicate “/X” and “FILE 1,” in accordance with the user's selections. The GUI 557 additionally includes options selectable by the user for specifying a backup schedule. In this example, the user may select whether the specified folder or file is to be backed up immediately (option 541), hourly (option 542), daily (option 543) or weekly (option 544). Fields 551, 552, 554, and 555 allow the user to more precisely specify a day of the week, time of day, and minute of the hour, as appropriate, at which the data is to be backed up. Other options may be available in alternative examples. The user may select one or more of the available options to inform the agent module 270 when the specified data set is to be backed up. The agent module 270 communicates the user's selections to the server module 435. The agent module 270 also stores the user's selection, for example in the storage device 111.

After the user selects a data set to back up and establishes one or more policies for backing up the selected data set, the agent module 270 backs up the data set in accordance with the specified policies. Referring now to the field 552 of FIG. 5, suppose that the user of the client 110 specifies that FILE 1 is to be backed up daily, at 10:00 PM each day. The agent module 270 monitors an internal clock (not shown) within the client 10 and, based on the user's specified parameters, begins to back up the data in FILE 1 when the clock indicates that the time is 10:00 AM.

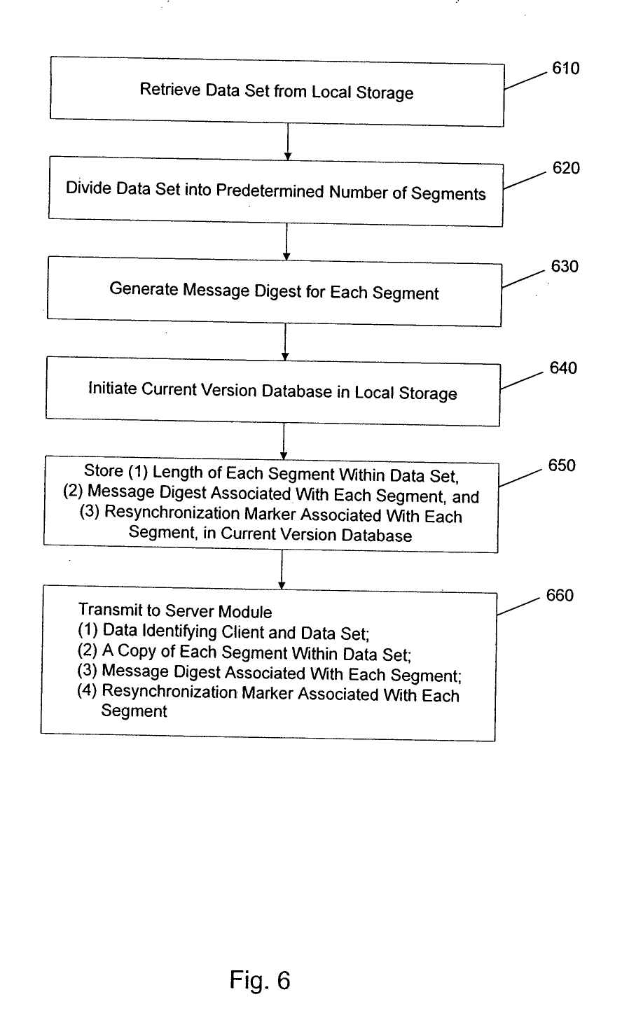

FIG. 6 is a flowchart of an example of a routine to back up a data set, in accordance with an embodiment of the invention. A data set may comprise one or more files, one or more folders, or any other data structure. At step 610, the data set is retrieved from local storage. At step 620 the data set is divided into a predetermined number of segments. The number of segments defined within a data set may be specified by a system administrator depending on various considerations such as desired speed, desired level of security, etc. The size of the segments may also be specified by the system administrator. Segments may be fixed-length or variable-length. Because the user in this example selected a file to be backed up, the segments are referred to as “file segments.”

During the first, initial backup of a data set, the agent module 270 divides the data set into segments containing a predetermined quantity of data. In this example, the agent module 270 defines within a data set segments containing 4 K of data. This size is referred to herein as the “standard file segment length” or alternatively the “standard-length.” It should be noted that the last segment defined during the initial backup procedure may have a shorter length. In addition, when subsequent versions of a file are backed up, in some circumstances, file segments having sizes that differ from the standard length may be defined. It should also be noted that while the agent module 270 in this example defines file segments having 4 K of data, any appropriate size may be selected for the file segments.

Segments within a data set are identified by version and segment. When a data set is first backed up, the backed up data is referred to as the first version of the data set, or version “1.” Subsequent versions are numbered sequentially. For the first version of a data set, all segments are stored and numbered. Accordingly, for the first version of FILE 1, the file segments within the file are referred to as segments “1.1,” “1.2,” “1.3,” etc. (For each subsequent version, only segments that are changed are numbered, counting up from “1.”).

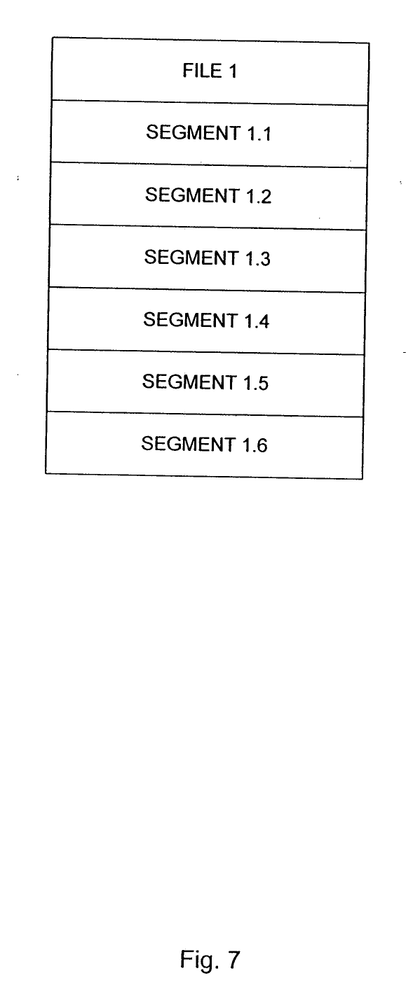

In this example, the data set selected by the user to be backed up comprises a single file, FILE 1, and the routine is executed by the agent module 270. Accordingly, the agent module 270 retrieves FILE 1 from the storage device 111 and divides FILE 1 into standard-length segments. FIG. 7 illustrates six file segments defined within FILE 1. The six segments are indicated as segments 1.1, 1.2, 1.3, 1.4, 1.5, and 1.6. Although in some cases the last file segment may be shorter than a standard-length file segment, in this example, it is assumed that file segment 1.6 is equal in length to a standard-length file segment. It should also be noted that although in this example, the agent server 270 retrieves a single file (FILE 1) and divides the file into segments, the routine outlined by FIG. 6 may be applied to a set of multiple files, to a set of one or more folders, or to any other data structure, for the purpose of backing up data. For example, the routine outlined in FIG. 6 may be used to back up folder 215 in its entirety.

Returning to FIG. 6, in step 630, a “message digest” is generated for each segment within the data set. In this instance, the agent module 270 generates a “message digest” for each file segment within FILE 1. A message digest refers to a value that represents the file segment. When the file segment is stored, the corresponding digest may be stored with (or separately from) the segment. Subsequently, the stored digest may be used to verify whether or not the file segment has been changed, or to reconstruct the segment.

The use of message digests to represent data, such as a file segment, is well-known. To be practical, a digest should be substantially smaller than the file segment. Ideally, each digest is uniquely associated with the respective file segment from which it is derived. A function which generates a unique digest for each file segment is said to be “collision-free.” In practice, it is sometimes acceptable to utilize a function that is substantially, but less than 100%, collision-free. Any one of a wide variety of functions can be used to generate a digest. For example, one well-known function is the cyclic redundancy check (CRC). Cryptographically strong hash functions are also often used for this purpose. A hash function performs a transformation on an input and returns a number having a fixed length—a hash value. Examples of hash functions include, but are not limited to, the message digest 5 (MD5) algorithm and the secure hash (SHA-1) algorithm. The MD5 and SHA-1 algorithms are well-known.

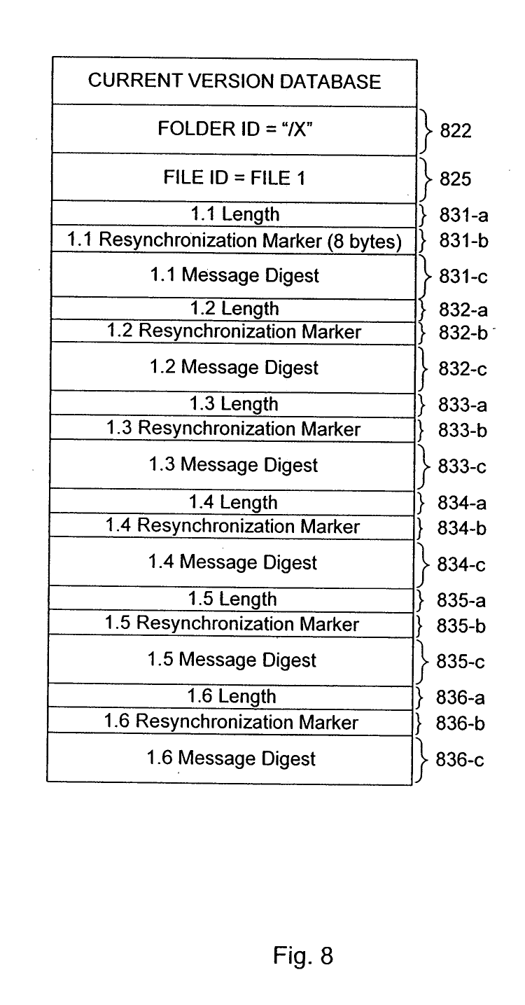

At step 640, a current version database is initiated in the local storage. In this example, the agent module 270 generally creates a separate current version database for each set of files or folders that is backed up, and therefore creates a current version database corresponding to FILE 1. FIG. 8 shows an example of a current version database 260 created to store data pertaining to FILE 1. Records 822 and 825 store a folder identifier and a file identifier, respectively. In this example, the folder identifier and file identifier may include the directory path “/X” and “FILE 1.” The current version database 260 is stored in the storage device 111.

At step 650, the length of each file segment within the data set, the message digest associated with each segment, and a resynchronization marker associated with each segment, are stored in the current version database. In this example, a resynchronization marker for each respective segment comprises the first eight bytes of the segment. Thus, in this example the agent module 270 stores (1) the length of each respective file segment within FILE 1; (2) the message digest corresponding to each respective file segment within FILE 1 and (3) the first eight bytes of each file segment within the file. The resynchronization marker may be subsequently used by the agent module 270 to identify file segments in the file, as discussed in greater detail below. While in this example, the resynchronization marker corresponding to a selected file segment comprises the first eight bytes of the file segment, the resynchronization marker may comprise any data block, of any size, within the file segment. For example, a resynchronization marker may comprise the last twelve bytes of a file segment. Referring again to FIG. 8, records 831-a, 831-b and 831-c store the length of file segment 1.1, the resynchronization marker associated with file segment 1.1, and the message digest associated with file segment 1.1, respectively. In a similar manner, records 832 through 836 store the segment lengths, resynchronization markers and message digests associated with file segments 1.2 through 1.6, respectively. While in this example the agent module 270 maintains a separate current version database for each set of files or folders that is backed up, the agent module 270 may alternatively maintain a single consolidated current version database to store data for multiple sets of files and folders that are backed up.

Referring now to step 660 of FIG. 6, the agent module 270 transmits to the server module 435 the following data: (1) data identifying the client and data set that are to be backed up; (2) a copy of each segment within the data set; (3) the message digest associated with each segment within the data set; and (4) a resynchronization marker associated with each segment within the data set, such as the first eight bytes of each file segment. Thus, in this example, the agent module 270 transmits to the server module 435 data identifying the client 110, the folder 215, and FILE 1. The agent module 270 additionally sends copies of the file segments 1.1, 1.2, 1.3, 1.4, 1.5, and 1.6, and the message digest corresponding to each of these file segments. The agent module 270 also transmits the first eight bytes of each file segment within FILE 1. The agent module 270 additionally transmits to the server module 435 a “version descriptor” listing the segments that make up the first version, which in this instance includes “1.1, 1.2, 1.3, 1.4, 1.5, 1.6.” The agent module 270 may also transmit to the server module 435 additional information such as date/time information, etc.

Any data transmitted by the agent module 270 to the server module 435 may be compressed in order to achieve a desired level of efficiency. Data transmitted by the agent module 270 to the server module 435 may also be encrypted in order to protect the data. The agent module 270 may use any well-known compression algorithm to compress data. Similarly, any one of a number of well-known encryption algorithms may be used to encrypt data, such as DES, 3DES or AES. In one example, the agent module 270 uses a symmetric key encryption technique to encrypt each file segment, prior to transmitting these data to the server module 435. The agent module 270 preserves the encryption keys (without transmitting them to the server module 435) so that the server module 435 cannot be used to access the encrypted data.

Server Module: Initial Backup

When the server module 435 receives data pertaining to one or more files and/or folders that are to be backed up, the server module 435 stores the information in the storage device 155. Referring to FIG. 4, the server module 435 may maintain a file object database 481 in the storage device 155 for the purpose of storing data received from the client 110. The technique of storing data in object oriented databases is well-known. Within a file object database, file objects are data structures that contain the actual data that is within the corresponding file, and metadata associated with the file. If multiple versions of a file exist, the versions are all stored within the same file object.

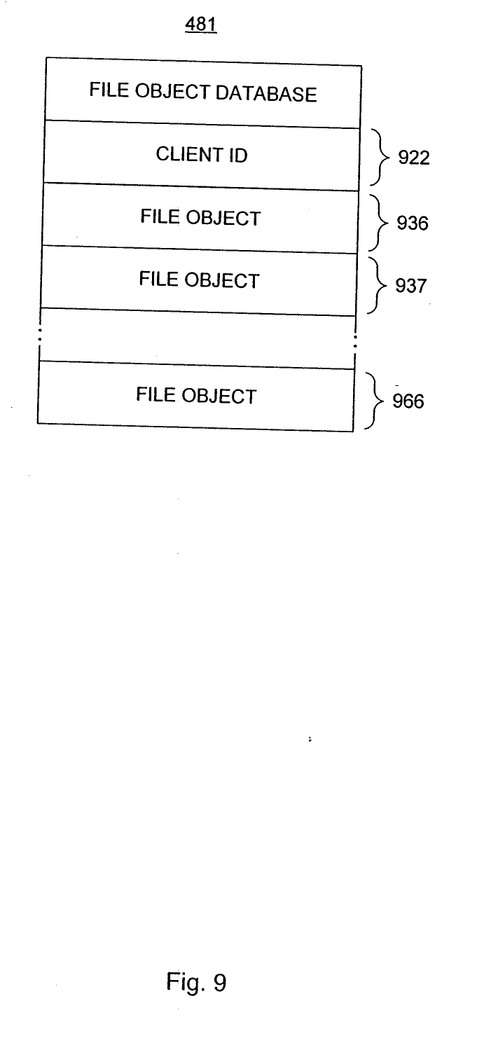

FIG. 9 illustrates an example of the file object database 481 which may be maintained to store data pertaining to various folders and files associated with the client 110. Field 922 holds a client identifier corresponding in this instance to the client 110. The file object database 481 additionally comprises one or more “objects” pertaining to various folders and files backed up by the client 110. For example, file objects 936 and 937 store data pertaining to folders and/or files previously backed up by the client 110.

Continuing the above example, when the server module 435 receives from the agent module 270 data pertaining to FILE 1, the server module 435 accesses the file object database 481 and creates a new file object 966 corresponding to FILE 1.

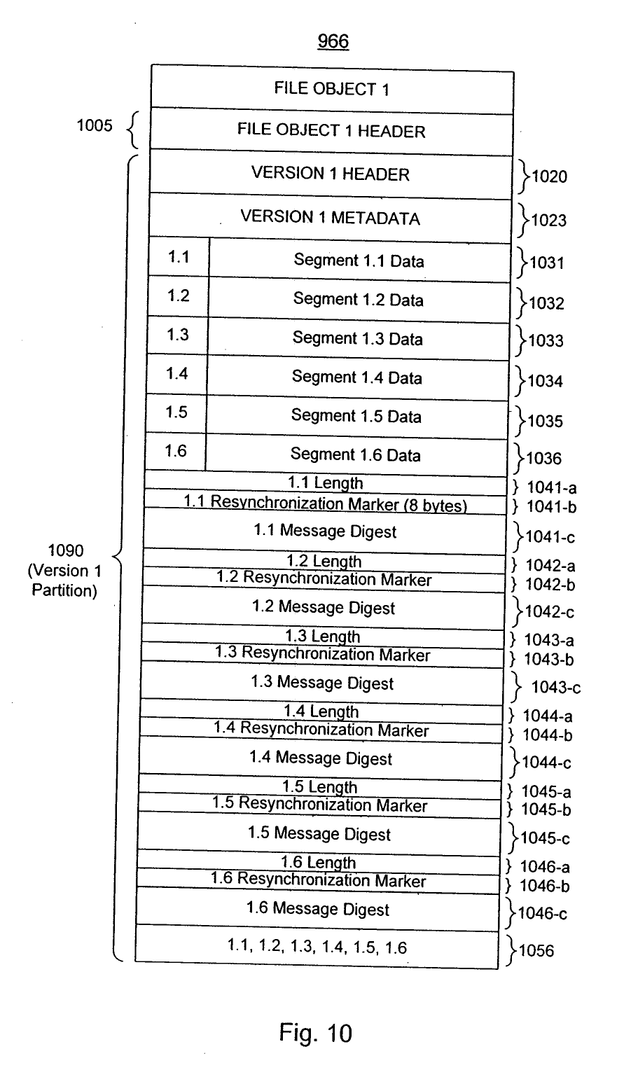

FIG. 10 shows an example of file object 966 in greater detail. The file object 966 comprises a file object header 1005 and a version partition 1090. The file object header 1005 includes information identifying the object, which in this instance may be the string, “Data Object.” The file object header 1005 also comprises an identifier of the most current version of the file, which in this instance may be simply “1,” indicating that there is currently only a single version of FILE 1. The file object header 1005 additionally identifies the originating client, which in this instance is the client 110, and the associated folder (folder 215).

The version partition 1090 holds information pertaining to the current version of FILE 1. Field 1020 contains version header information pertaining to the current version of FILE 1, such as the total number of file segments in the version, the total length of the partition, information pertaining to the encryption algorithm used (if any) and the compression algorithm used (if any), etc. Field 1023 includes metadata pertaining to the current version of FILE 1, such as security information, and other extended attribute information associated with the data set. Fields 1031 through 1036 hold copies of file segments 1.1 through 1.6, respectively. Alternatively, these fields may contain pointers to the locations of the data. Using pointers can enhance performance (in terms of speed) and/or allow greater flexibility in physical storage allocation. Each of fields 1031 through 1036 also includes a sub-field that holds an indicator, referred to as a “segment label,” associated with the respective segment stored therein. Thus, for example, field 1031 includes the segment label “1.1” indicating that it contains segment 1.1 of FILE 1, field 1032 holds the segment label “1.2” indicating that it contains segment 1.2 of FILE 1, etc.

Each of records 1041-1046 stores information pertaining to the segment length, the resynchronization marker and the message digest corresponding to a respective one of segments 1.1 through 1.6. For example, fields 1041-a, 1041-b and 1041-c hold, respectively, segment length information, a resynchronization marker and a message digest corresponding to file segment 1.1. The field 1056 holds data referred to as a version descriptor. The version descriptor comprises a list of segment labels corresponding to the segments that make up the current version of FILE 1. Referring to field 1056 of FIG. 10, the current version of FILE 1 comprises the segments corresponding to the segment labels “1.1,” “1.2,” “1.3,” “1.4,” “1.5,” and “1.6.”

Subsequent Backup: Example I: Data Added to End of File

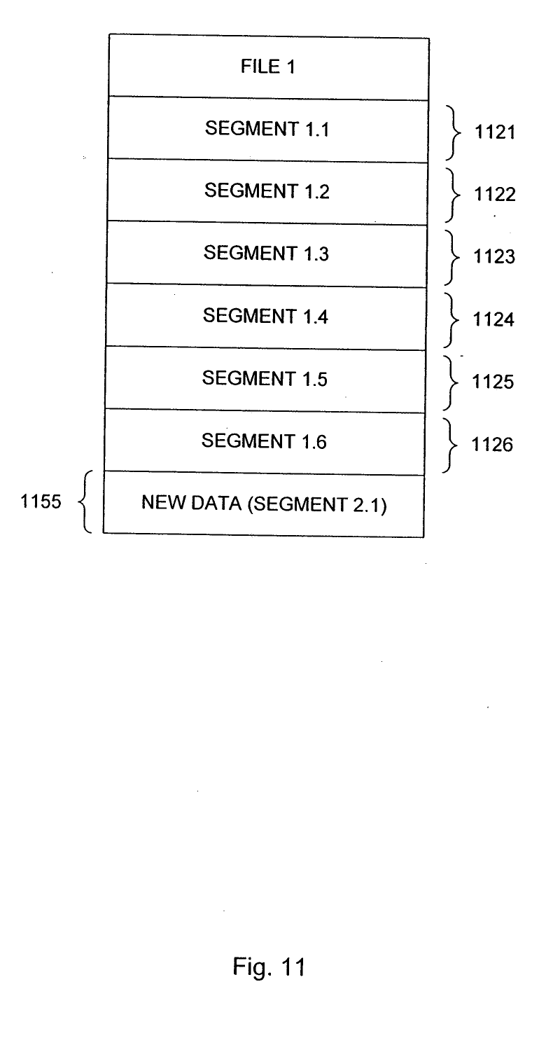

After data is backed up by the server module 435 in the file object database 966, changes to the data are recorded as additional versions. For example, suppose now that the user of client 110 accesses FILE 1 via the client 110 and changes the contents of FILE 1 by appending new data to the end of the file. FIG. 11 shows an example of an updated FILE 1 containing a new data block 1155 located after segments 1.1 through 1.6. The user stores the updated version of FILE 1 in the storage device 111.

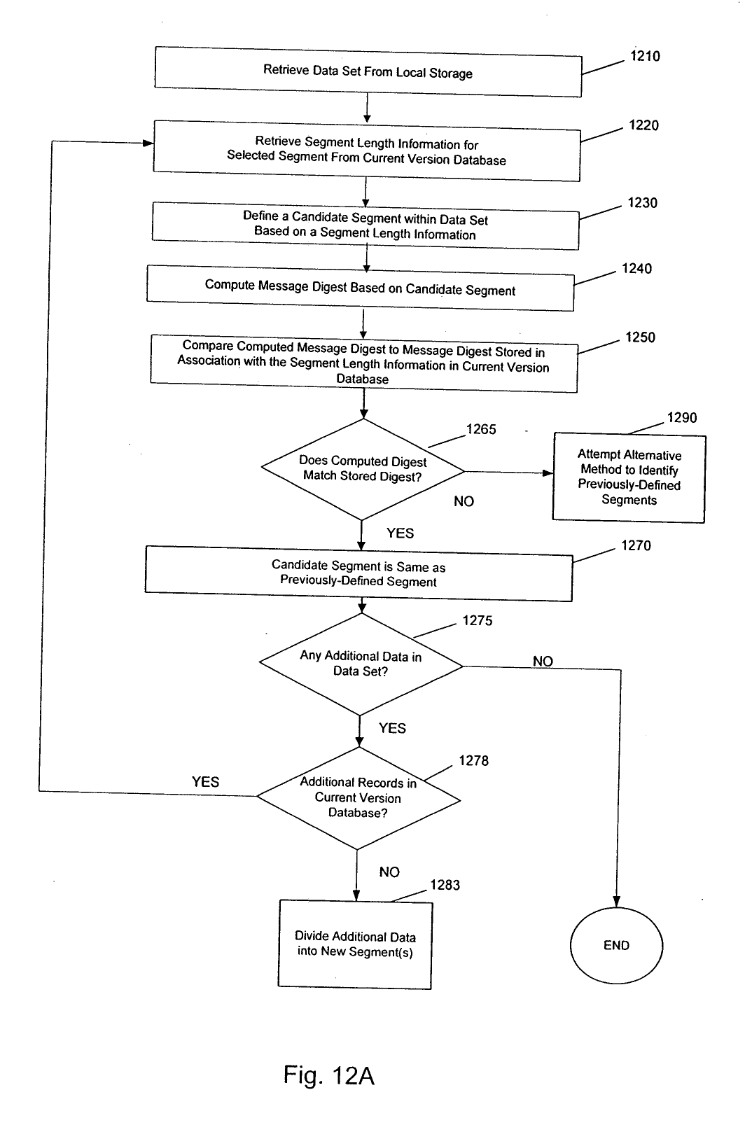

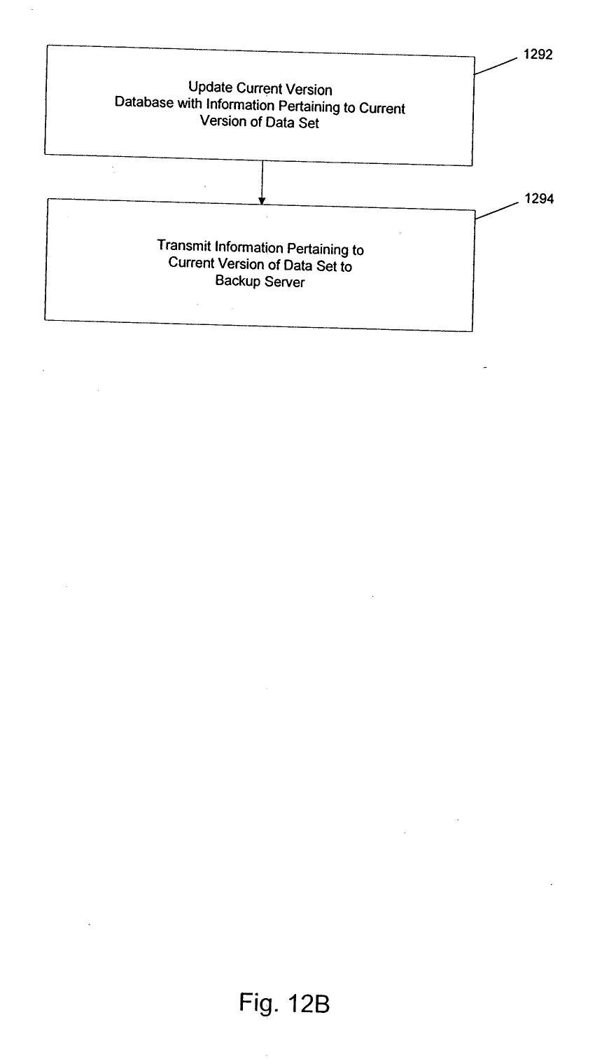

Agent module 270 continues to back up the file in accordance with the policies previously set by the user. Thus, the next time the agent module 270 determines that the time is 10:00 AM, the agent module 270 again backs up the file. FIG. 12 is a flowchart of an example of a method for backing up a data set that has been updated. In accordance with an embodiment of the invention, the data set is retrieved from local storage at step 1210. The current version database associated with the data set is accessed, and at step 1220 segment length information pertaining to a selected segment is retrieved from the current version database. In one example, records within the current version database are examined starting at the beginning of the database and working toward the end of the database. At step 1230 a candidate segment is defined within the data set based on the retrieved segment length information. In this example, candidate segments are defined starting at the beginning of the data set and moving toward the end of the data set. At step 1240 a message digest is computed from the candidate segment. At step 1250 the computed message digest is compared to the message digest stored in the current version database in association with the segment length information. Referring to block 1265, if the computed message digest matches the stored message digest, the candidate segment is determined to be the same as the previously-defined segment (block 1270). At this point, in accordance with block 1275, if the data set does not contain any more data, the routine comes to an end. If additional data remains in the data set, the routine proceeds to block 1278 and the current version database is examined to determine whether or not there is an additional information therein. If there are additional records within the current version database that have not yet been analyzed, the routine returns to step 1220 and additional candidate segments may be defined and analyzed.

In this example, the data set is FILE 1 and the routine described in FIG. 12 is performed by the agent module 270. The agent module 270 at step 1210 retrieves the current version of FILE 1 from the storage device 111. The agent module 270 accesses the current version database 260 (shown in FIG. 8) and, at step 1220, retrieves segment length information for a selected file segment. Starting from the beginning of the current version database 260, the agent module 270 in this instance retrieves segment length information from field 831-a of the current version database 260, which pertains to the previously-defined segment 1.1.

At step 1230 the agent module 270 defines a candidate file segment within FILE 1 based on the retrieved segment length information. In this example, the agent module defines candidate file segments starting from the beginning of FILE 1. Referring to FIG. 11, then, the agent module 270 defines candidate segment 1121. At step 1240, the agent module computes a message digest based on the candidate segment 1121, and at step 1250 compares the computed message digest to the message digest stored in the current version database 260 in association with the segment length information. In this instance, the agent module 270 compares the computed message digest to the message digest stored in field 831-c of the current version database 260, which corresponds to the previously-defined file segment 1.1.

In this example, the computed message digest matches the stored digest, and thus, in accordance with block 1265, the agent module 270 proceeds to step 1270 and determines that the candidate segment 1121 is in fact the same as the previously-defined segment 1.1. Referring to block 1275, because there remains additional data within FILE 1 to analyze, the agent module 270 again examines the current version database 260 and finds additional records therein (block 1278). The routine therefore returns to step 1220.

The procedure is now repeated. The agent module again accesses the current version database 260, retrieves the segment length information pertaining to segment 1.2 from field 832-a, and uses the segment length information to define another candidate file segment within FILE 1. In this instance, the agent module 270 defines candidate segment 1122. A message digest is computed based on candidate segment 1122, and compared to the message digest stored in field 832-c of the current version database 260 (which corresponds to the previously-defined file segment 1.2). In this example, the computed digest matches the stored digest, and it is therefore determined that the candidate file segment matches the previously-defined file segment 1.2.

The agent module 270 repeats the routine described in step 1220-1275 of FIG. 12 several additional times, defining in turn candidate segments 1123, 1124, 1125 and 1126, and determining that these candidate segments are respectively the same as the previously-defined file segments 1.3, 1.4, 1.5, 1.6.

After the agent module 270 determines that the candidate segment 1126 matches the previously-defined file segment 1.6, the agent module 270 determines at block 1275 that there still remains additional data within FILE 1. However, referring to block 1278, the agent module 270 examines the current version database 260 and finds that there are no unexamined records therein. Thus, proceeding to step 1283, the agent module 270 divides the new data block 1155 into one or more file segments. In this instance, the new data block 1155 is defined as a single standard-length file segment, as shown in FIG. 11.

The agent module 270 now backs up the current version of FILE 1. FIG. 12B is a flowchart of an example of a method for backing up a data set, in accordance with an embodiment of the invention. At step 1292, the current version database 260 is updated with information pertaining to the current version of the data set. At step 1294, information pertaining to the current version of the data set is transmitted to the backup server 140.

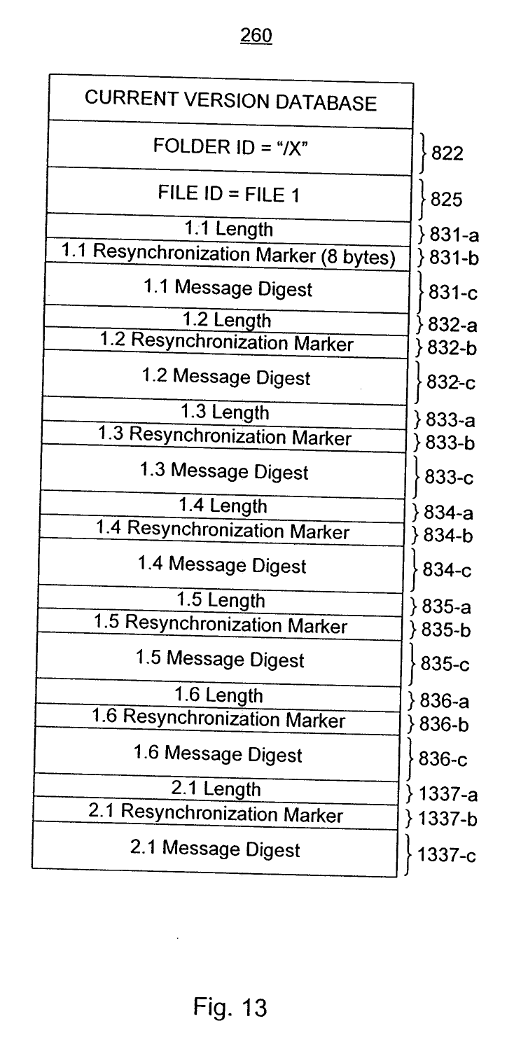

The actions required to update the current version database 260 vary depending on the nature of the changes in the data set. In this example, the agent module 270 stores segment length information, the message digest(s) and resynchronization marker(s) corresponding to the new data block 1155 in the current version database 260. The new file segment containing the new data block 1155 is assigned a segment label. Because this is the second time that the file is being backed up, the version is designated “2.” Because one and only one segment within FILE 1 is different from the previous version, and thus a single new message digest is stored, the new segment is assigned the label “2.1,” as shown in FIG. 11. FIG. 13 is an example of an updated current version database. The agent module 270 stores segment length information, a resynchronization marker comprising the first eight (8) bytes of the file segment 2.1, and the message digest corresponding to the file segment 2.1, in records 1337-a, 1337-b, and 1337-c, respectively, of the current version database 260.

Referring back to FIG. 12B, at step 1292 the agent module 270 transmits to the server module 435 the following information: (1) data identifying the client, folder and file that are to be backed up; (2) a copy of the current version of each new/changed file segment within the file; (3) the message digest corresponding to each new/changed segment within the file; and (4) a resynchronization marker associated with each new/changed segment within the file. Thus, the agent module 270 transmits to the server module 435 data identifying client 110, folder 215, and FILE 1, a copy of the new file segment 2.1, a copy of the message digest corresponding to the segment 2.1, and the first eight bytes of the new file segment 2.1. The agent module 270 may additionally transmit to the server module 435 a version descriptor listing the segments that make up the second version, which in this instance includes “1.1, 1.2, 1.3, 1.4, 1.5, 1.6, 2.1.” The agent module 270 may also transmit to the server module 435 additional information such as date/time information.

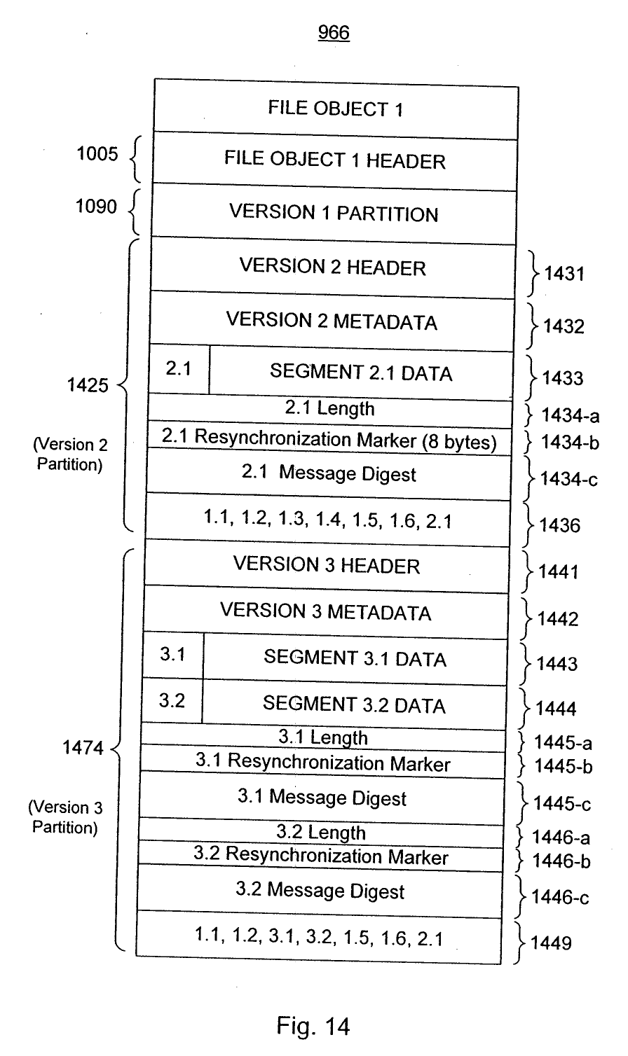

When the server module 435 receives from the agent module 270 the data pertaining to FILE 1, the server module 435 accesses the file object database 481 and determines that the file object 966 corresponding to FILE 1 already exists. The server module 435 further examines the file object 966 and determines that it already includes file object header 1005 and version 1 partition 1090. The server module 435 updates the file object 1 header as necessary. Referring to FIG. 14, the server module 435 also creates a new version partition 1425 (the “version 2 partition”) to store the data pertaining to the recent changes to FILE 1 in the file object 966. The version 2 partition 1425 comprises version 2 header 1431 and version 2 metadata 1432. Field 1433 stores a copy of the new segment 2.1, and the segment label “2.1.” Fields 1434-a, 1434-b, and 1434-c comprise, respectively, the segment length information, the resynchronization marker and the message digest corresponding to the file segment 2.1. Field 1436 holds a version descriptor listing the segments that make up the second version. In this instance, the version descriptor field 1436 comprises “1.1, 1.2, 1.3, 1.4, 1.5, 1.6, 2.1.”

Subsequent Backup: Example II: Text in One or More File Segments Replaced

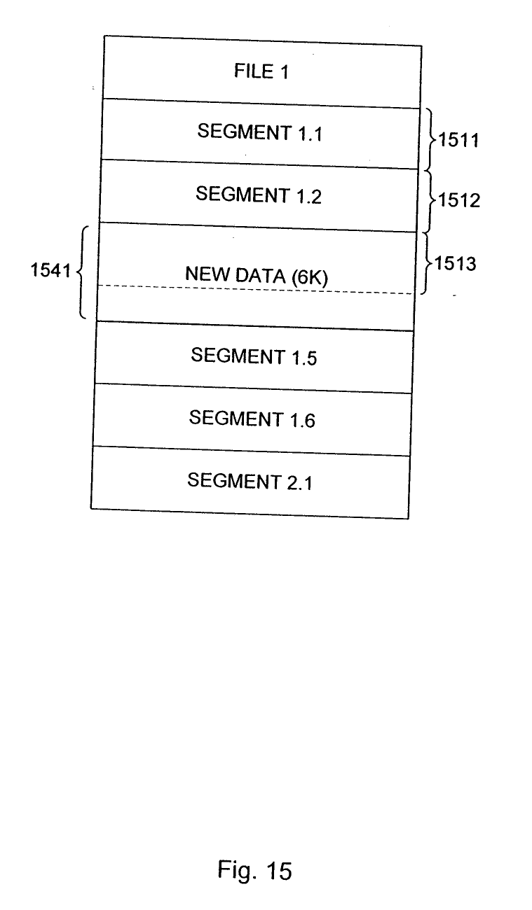

Supposing now that the user again changes FILE 1 by altering the data within the file. Referring to FIG. 15, the user now deletes file segments 1.3 and 1.4 and inserts new data block 1541. In this example, data block 1541 comprises 6 kilobytes (6K) of data, and thus is equal in size to one and one-half standard-length file segments.

When the agent module 270 again backs up FILE 1, the agent module 270 repeats steps outlined in FIG. 12A. The agent module 270 retrieves FILE 1 from storage (step 1210), accesses the current version database 260 (shown in FIG. 13) and retrieves segment length information pertaining to a selected file segment (step 1220). Starting from the beginning of the current version database 260, the agent module 270 retrieves from field 831-a the segment length information corresponding to previously-defined segment 1.1. Referring again to FIG. 15, the agent module 270 defines a candidate segment 1511 within FILE 1 based on the retrieved segment length information (step 1230), computes a message digest based on the candidate segment 1511 (step 1240), and compares the computed digest to the corresponding message digest stored in the current version database 260 (step 1250). In this example, the agent module 270 compares the computed message digest to the message digest stored in field 831-c of the current version database 260. In this instance, the agent module 270 determines that the message digests match and that, therefore, the candidate file segment 1511 matches the previously-defined file segment 1.1 (step 1270). Because there is additional data remaining in FILE 1, the agent module 270 examines the current version database 260 and finds additional records stored therein. Thus, in accordance with block 1278, the agent module 270 returns to step 1220. The agent module 270 accesses the current version database 260 and retrieves segment length information (now from field 832-a), and defines another candidate file segment 1512 based on the segment length information, as shown in FIG. 15. The agent module 270 computes a message digest based on the candidate file segment 1512 and compares it to the message digest stored in field 832-c of the current version database 260. The agent module 270 finds that the two digests match and that therefore the previously-defined file segment 1.2 also has not been changed.

The procedure is repeated again. At step 1220 the agent module 270 retrieves the segment length information from field 833-a in the current version database 260 (shown in FIG. 13), which corresponds to previously-defined file segment 1.3. The agent module 270 defines a candidate file segment 1513 within FILE 1 based on the retrieved segment length information. As shown in FIG. 15, the candidate file segment 1513 comprises a portion of the new data block 1541, which was inserted by the user in place of the previously-defined file segments 1.3 and 1.4. The agent module 270 computes a message digest from the candidate file segment 1513 and compares the computed segment to the message digest stored in field 833-c of the current version database 260 (which corresponds to previously-defined file segment 1.3). In this example, the computed digest and the stored message digest do not match. Thus, referring to block 1265 of FIG. 12A, the agent module 270 proceeds to step 1290 and attempts an alternative method to identify previously-defined file segments within FILE 1.

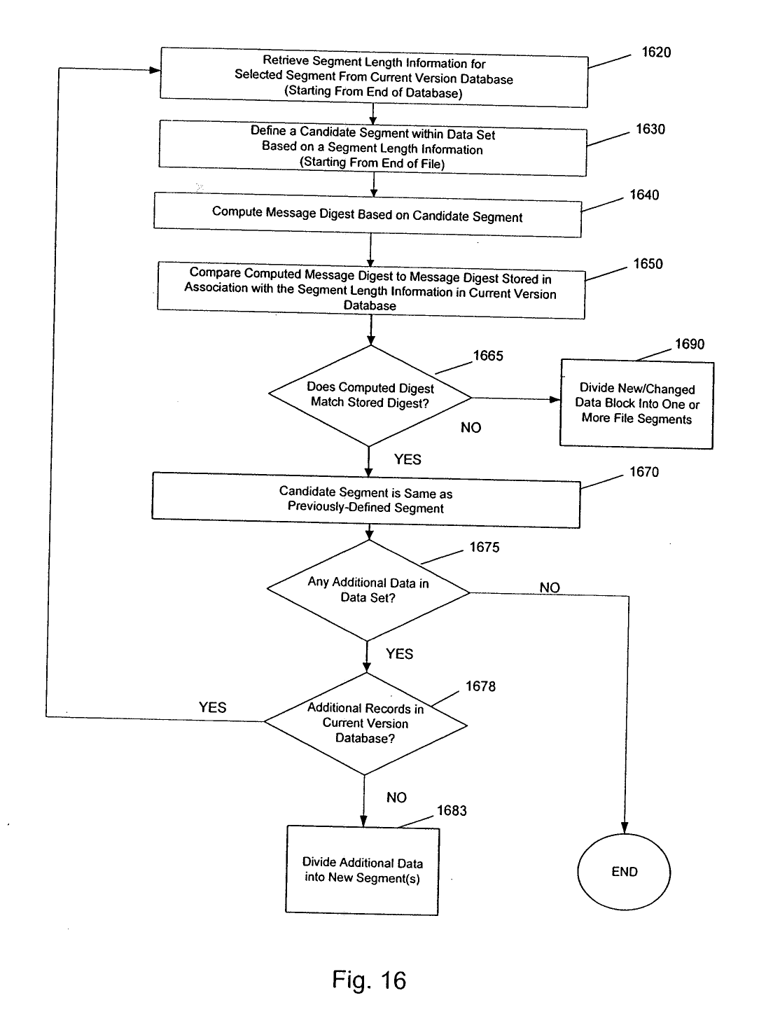

FIG. 16 is a flowchart of an example of an alternative method to identify previously-defined file segments within a data set, in accordance with an embodiment of the invention. The method described in FIG. 16 is similar to the method shown in FIG. 12A; however, in this routine the records within the current version database 260 are examined starting from the end of the database and moving toward the beginning of the database. Similarly, candidate file segments are defined starting at the end of the file and moving toward the beginning of the file. It is sometimes easier to identify previously-defined file segments starting from the end of the file rather than by starting from the beginning—where, for example, data in the beginning of the file has been altered but the data at the end of the file remains unchanged.

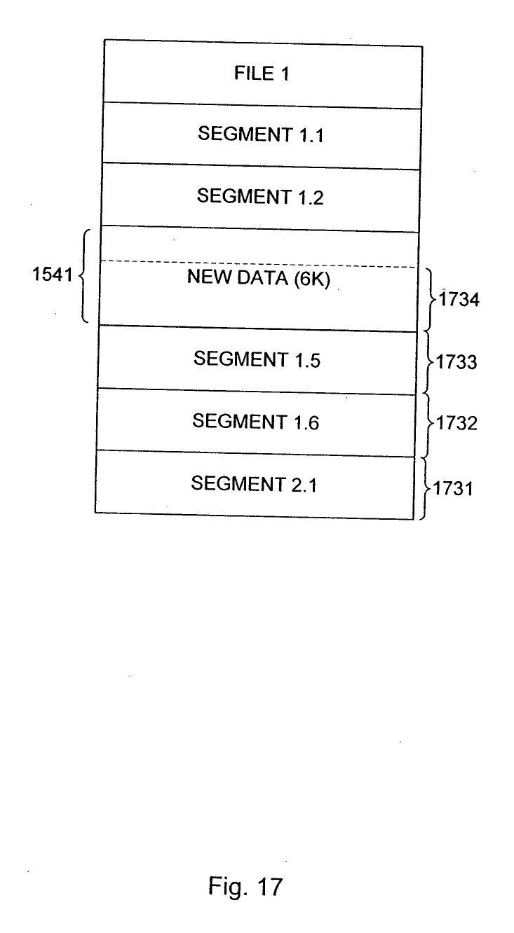

Thus, at step 1620, the agent module 270 retrieves segment length information from the current version database 260 (shown in FIG. 13), starting now from the end of the database. Referring to FIG. 13, the agent module 270 retrieves from field 1337-a the segment length information corresponding to the previously-defined file segment 2.1. At step 1630, a candidate file segment is defined within the file based on the retrieved segment length information, starting from the end of the file. Thus, as shown in FIG. 17, the agent module 270 defines a candidate file segment 1731 at the end of FILE 1 based on the retrieved segment length information. The agent module 270 computes a message digest based on the candidate file segment 1731 (step 1640). At step 1650 the computed message digest is compared to the message digest that is stored in association with the retrieved segment length information. In this instance the computed message digest is compared to the message digest stored in field 1337-c of the current version database 260, which corresponds to the previously-defined file segment 2.1. In this example, the computed message digest matches the stored message digest, and thus in accordance with block 1665 the agent module 270 proceeds to step 1670 and determines that the candidate file segment 1731 is the same as the previously-defined file segment 2.1. Referring to block 1675, because there remains unexamined data within FILE 1, the routine proceeds to block 1678. The agent module 270 examines the current version database 260 and finds additional records that have not been examined. Thus, the routine returns to step 1620, and the agent module 270 repeats the procedure described by steps 1620-1660 of FIG. 16. Working from the end of the current version database 260 toward the beginning of the database, and from the end of FILE 1 toward the beginning of the file, the agent module 270 defines candidate file segment 1732 and, in the manner described above, determines that it is the same as previously-defined file segment 1.6. In a similar manner, the agent module 270 defines a candidate file segment 1733, and determines that it matches the previously-defined file segment 1.5.

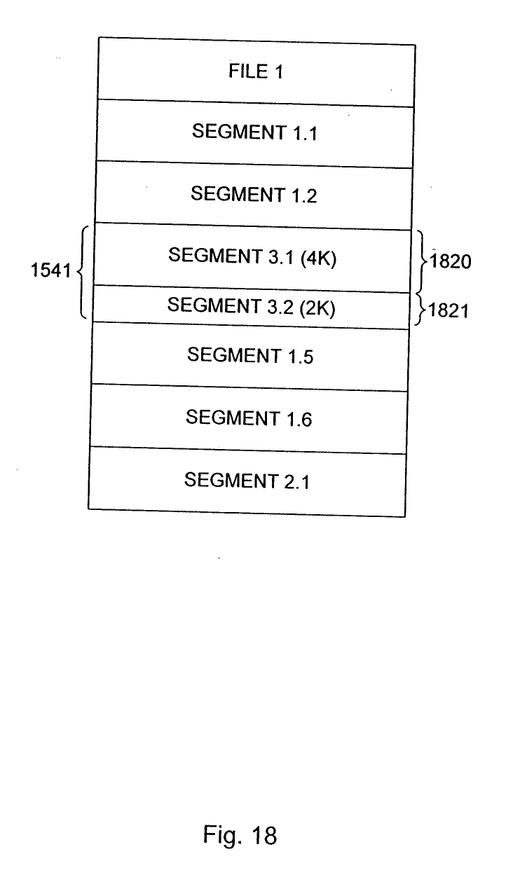

After determining that the candidate file segment 1733 is the same as the previously-defined file segment 1.5, the agent module 270 again retrieves segment length information from the current version database 260. In this instance the agent module 270 retrieves from field 834-a segment length information corresponding to the previously defined file segment 1.4. The agent module 270 defines a candidate file segment 1734 within FILE 1 based on the retrieved segment length information. In this example, the candidate file segment 1734 contains a portion of the new data block 1541. Thus, when a message digest is computed based on the candidate file segment 1734 and is compared to the corresponding message digest stored in field 834-c of the current version database 260 (which corresponds to the previous file segment 1.4), the computed message digest does not match the stored message digest. Thus, in accordance with block 1665, the agent module 270 proceeds to step 1690. The agent module 270 concludes that the data block 1541 located between previously defined segment 1.2 and previously-defined segment 1.5 does not correspond to any previously-defined file segment, and divides the data block into one or more file segments. Referring to FIG. 18; the agent module 270 defines one standard-length file segment 1820, comprising four kilobytes (4K) of data and one file segment 1821 comprising two kilobytes (2K) of data. It should be noted that in alternative examples, the data that does not correspond to any previously-defined file segment may be divided into any number of file segments, of any size.

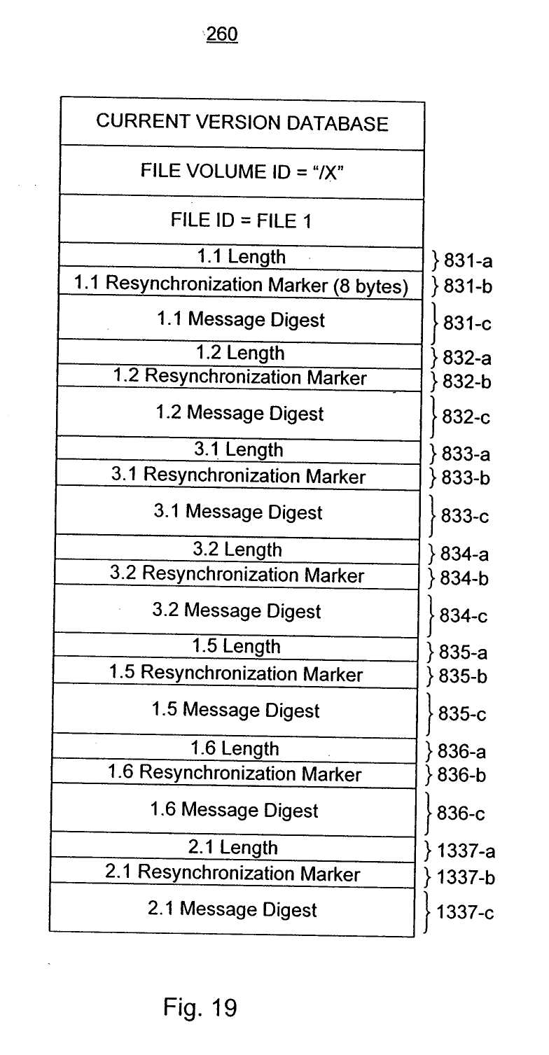

The agent module 270 now backs up the current version of FILE 1, in accordance with the routine described in FIG. 12B. At step 1292, the agent module 270 updates the current version database 260 with information pertaining to the current version of FILE 1. The agent module 270 stores the segment length information, message digest(s) and resynchronization marker(s) corresponding to the newly-defined file segments 1820 and 1821 in the current version database 260. The file segments containing the new segments 1820 and 1821 are assigned segment labels. Because this is the third time that FILE 1 is being backed up, the version is designated “3.” Because two segments within FILE 1 are different from the previous version, and thus two message digests are stored, the new file segments are assigned the segment labels “3.1” and 3.2, respectively. Referring now to FIG. 19, the agent module 270 stores segment length information pertaining to file segment 3.1, a resynchronization marker comprising the first eight (8) bytes of the file segment 3.1, and the message digest corresponding to the file segment 3.1, in records 833-a, 833-b and 833-c, respectively, of the current version database 260. Similarly, the agent module 270 stores segment length information for file segment 3.2, a resynchronization marker comprising the first eight (8) bytes of the file segment 3.2, and the message digest corresponding to the file segment 3.2, in records 834-a, 834-b and 834-c, respectively.

Referring to step 1294 of FIG. 12B, the agent module 270 transmits to the server module 435 data identifying client 110, folder 215, and FILE 1, copies of the new file segments 3.1 and 3.2, copies of the message digests corresponding to new file segments 3.1 and 3.2, and the first eight bytes of each file segments 3.1 and 3.2, as discussed above. The agent module 270 may additionally transmit to the server module 435 additional information including a version descriptor, date/time information, etc.

When the server module 435 receives from the agent module 270 the data pertaining to the recent changes made to FILE 1, the server module 435 accesses the file object database 481 (shown in FIG. 14) and determines that the file object 966 corresponding to FILE 1 already exists. The server module 435 further examines the file object 966 and determines that it already includes file object header 1005, version 1 partition 1090 and version 2 partition 1425. Referring to FIG. 14, the server module 435 accordingly updates the file object header 1005 as necessary and creates a new version partition 1474 (the “version 3 partition”) to store the data pertaining to the most recent changes to FILE 1. The version 3 partition 1474 comprises version 3 header 1441 and version 3 metadata 1442. Field 1443 stores a copy of the new segment 3.1, and the segment label “3.1.” Field 1444 stores a copy of the new segment 3.2 and the segment label “3.2.” Fields 1445-a, 1445-b, and 1445-c comprise, respectively, the segment length information, resynchronization marker and the message digest corresponding to the file segment 3.1. Fields 1446-a, 1446-b and 1446-c comprise, respectively, the segment length information, resynchronization marker and the message digest corresponding to the file segment 3.2. Field 1449 holds a version descriptor listing the segments that make up the third version. In this instance, the version descriptor field 1449 comprises “1.1, 1.2, 3.1, 3.2, 1.5, 1.6, 2.1.”

Subsequent Backup: Example III: Portion of File Segment Deleted

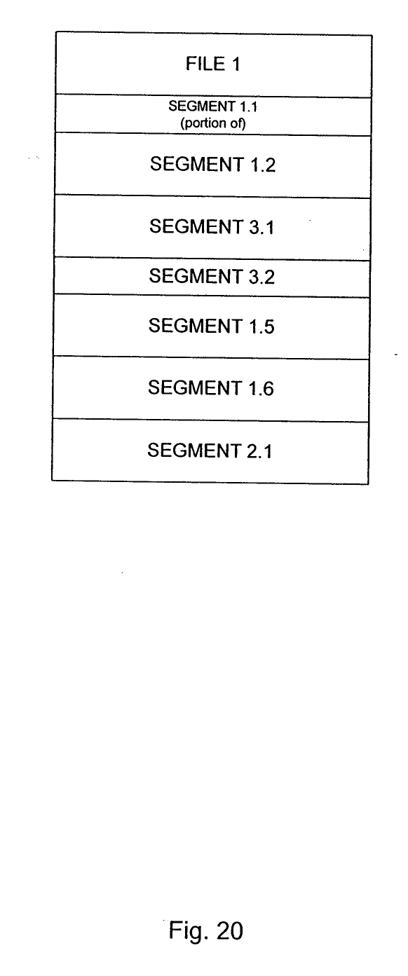

The agent module 270 may use other techniques in addition to those described above to determine how a file has been changed and/or to identify previously-defined file segments within a file. By way of example, suppose that the user now changes FILE 1 by deleting the first half of the data within segment 1.1. FIG. 20 shows a modified version of FILE 1 containing only a portion of the previously-defined segment 1.1.

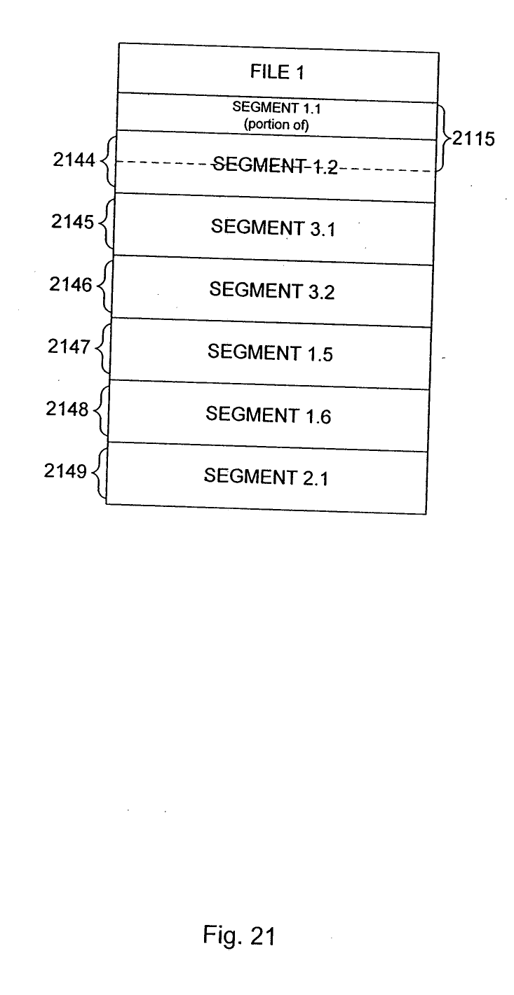

When the agent module 270 next backs up FILE 1, the agent module 270 repeats the steps outlined in FIG. 12A. The agent module 270 retrieves FILE 1 from storage (step 1210) and accesses the current version database 260 (shown in FIG. 19). At step 1220, segment length information is retrieved from field 831-a of the current version database 260, and at step 1230 a candidate file segment is defined based on the retrieved segment length information. FIG. 21 shows a candidate file segment 2115 defined within FILE 1 based on the retrieved segment length information. Because a portion of the previously-defined file segment 1.1 has been deleted, the candidate segment 2115 contains a portion of previously-defined file segment 1.1 and a portion of previously-defined file segment 1.2.

In accordance with step 1240, the agent module 270 computes a message digest based on the candidate file segment 2115 and compares the computed message digest to the message digest stored in field 831-c of the current version database 260 (step 1250). In this example, the agent module 270 determines that the message digest computed based on the candidate file segment 2115 does not match the stored message digest.

Referring to block 1265, because the computed message digest and the stored message digest are not the same, the agent module 270 proceeds to step 1290. The agent module 270 disregards the candidate file segment 2115 and attempts an alternative method to identify previously-defined file segments within FILE 1. In this example, the agent module 270 selects an alternative approach in which the resynchronization markers stored in the current version database 260 are used to identify previously defined file segments in FILE 1.

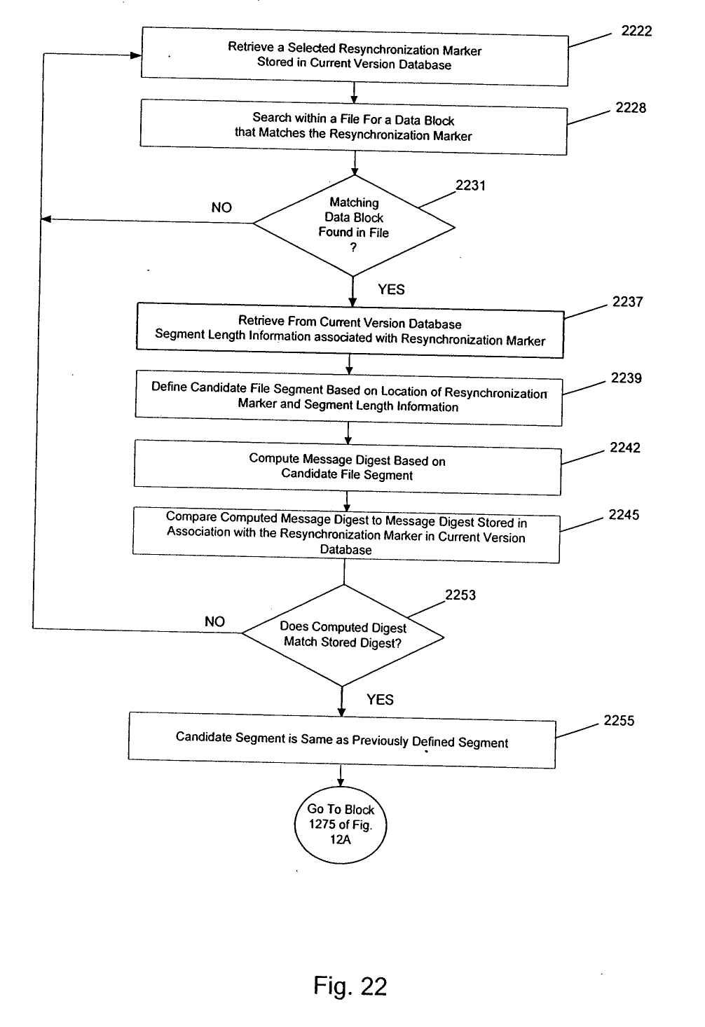

FIG. 22 is a flowchart of an example of a method to identify previously defined file segments in a file using resynchronization markers, in accordance with an embodiment of the invention. At step 2222, the agent module 270 retrieves a selected resynchronization marker stored in the current version database 260, and at step 2228 searches within the file for a data block that match the resynchronization marker. In this example, the agent module 270 retrieves the resynchronization marker from record 831-b in the current version database 260 (shown in FIG. 19). In this instance, the resynchronization marker corresponds to the previously-defined file segment 1.1 and comprises an eight-byte data block. The agent module 270 then searches through the data in FILE 1 for an eight-byte data block matching the retrieved resynchronization marker. Because the beginning portion of segment 1.1 (including the first eight-bytes thereof) was deleted, no eight-byte data block corresponding to the segment 1.1 resynchronization marker is found.

In accordance with block 2231, the routine returns to step 2222. The agent module 270 now retrieves from field 832-b of the current version database 260 the resynchronization marker corresponding to previously-defined file segment 1.2, and searches through the data in FILE 1 for a matching eight-byte data block (step 2228). The agent module 270 finds an eight-byte data block matching the segment 1.2 resynchronization marker near the beginning of FILE 1. Thus, in accordance with block 2231, the agent module 270 proceeds to step 2237 and retrieves from the current version database 260 the segment length information associated with the resynchronization marker. In this example, the agent module 270 retrieves from field 832-a of the current version database 260 the segment length information for the previously-defined file segment 1.2. Referring to FIG. 21, the agent module 270 defines a candidate file segment 2144 within FILE 1 based on the location of the segment 1.2 resynchronization marker and the segment 1.2 segment length information (step 2239). At step 2242, the agent module 270 computes a message digest based on the candidate file segment 2144, and at step 2245 compares the computed message digest to the message digest stored in the current version database 260 in association with the resynchronization marker—which is in this instance the message digest stored in field 832-c. In this example, the computed message digest matches the stored message digest; thus, in accordance with block 2253, the agent module 270 proceeds to step 2255 and concludes that the candidate file segment 2144 is the same as the previously-defined file segment 1.2. The routine now proceeds to block 1275 of FIG. 12A.

In accordance with the routine described in FIG. 12A, the agent module 270 examines FILE 1 and the current version database 260 and, finding that there remains additional data in the file and unexamined records in the current version database, returns to step 1220. Referring again to FIG. 21, the agent module 270 defines another candidate file segment 2145, computes a message digest based on the candidate file segment 2145, and compares the computed message digest to a corresponding message digest stored in the current version database 260 (which in this instance is stored in field 833-c and corresponds to the previously-defined file segment 3.1). In this example, the computed digest matches the stored digest, and the agent module 270 therefore determines that the candidate file segment 2145 is the same as the previously-defined file segment 3.1.

Repeating the routine described in FIG. 12A, the agent module 270 defines, in turn, candidate file segments 2146, 2147, 2148 and 2149 and determines that these candidate file segments correspond respectively to the previously-defined file segments 3.2, 1.5, 1.6, and 2.1.

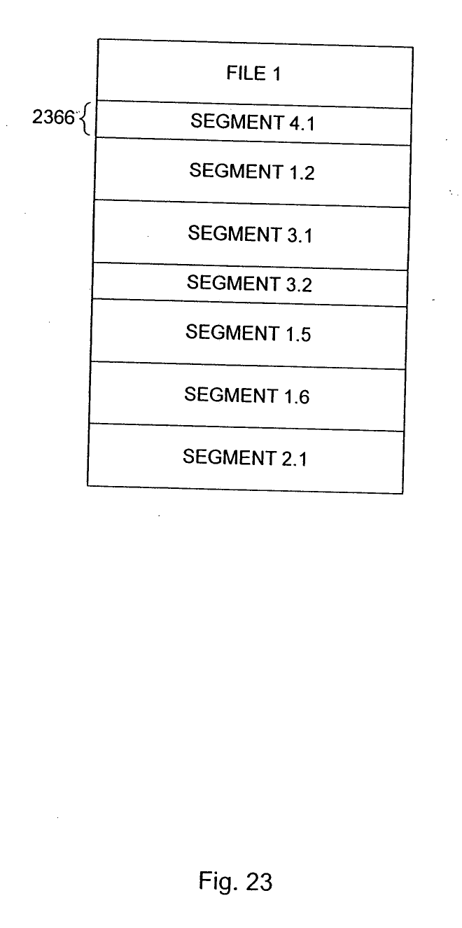

The agent module 270 concludes that the only part of FILE 1 that does not correspond to a previously-defined file segment is the remaining portion of the previously-defined file segment 1.1 that was not deleted. The agent module 270 therefore defines a new file segment 2366 containing the data from the previously-defined file segment 1.1, as shown in FIG. 23.

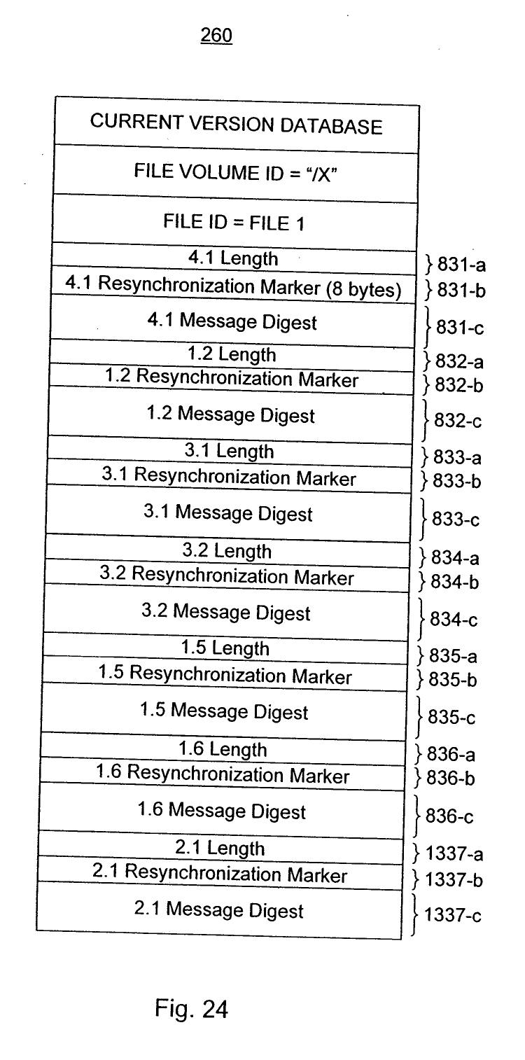

The agent module 270 now updates the current version database 260. The agent module 270 stores in the current version database 260 the segment length information, the message digest and resynchronization marker corresponding to the newly-defined file segment 2366 of FILE 1. The file segment 2366 is also assigned a segment label. Because this is the fourth time that FILE 1 is being backed up, the version is designated “4.” Because one segment within FILE 1 is different from the previous version, the new file segment 2366 is assigned the segment label “4.1,” as indicated in FIG. 23. FIG. 24 shows an updated current version database 260 in which segment length information corresponding to the new file segment 4.1, a resynchronization marker comprising the first eight (8) bytes of the file segment 4.1, and the message digest corresponding to the file segment 4.1, are stored in fields 831-a, 831-b, and 831-c, respectively.

The agent module 270 transmits to the server module 435 data identifying client 110, folder 215, and FILE 1, a copy of the new file segment 4.1, a copy of the message digest corresponding to new file segments 4.1, and the first eight bytes of the file segment 4.1. The agent module 270 may additionally transmit to the server module 435 additional information including a version descriptor, date/time information, etc.

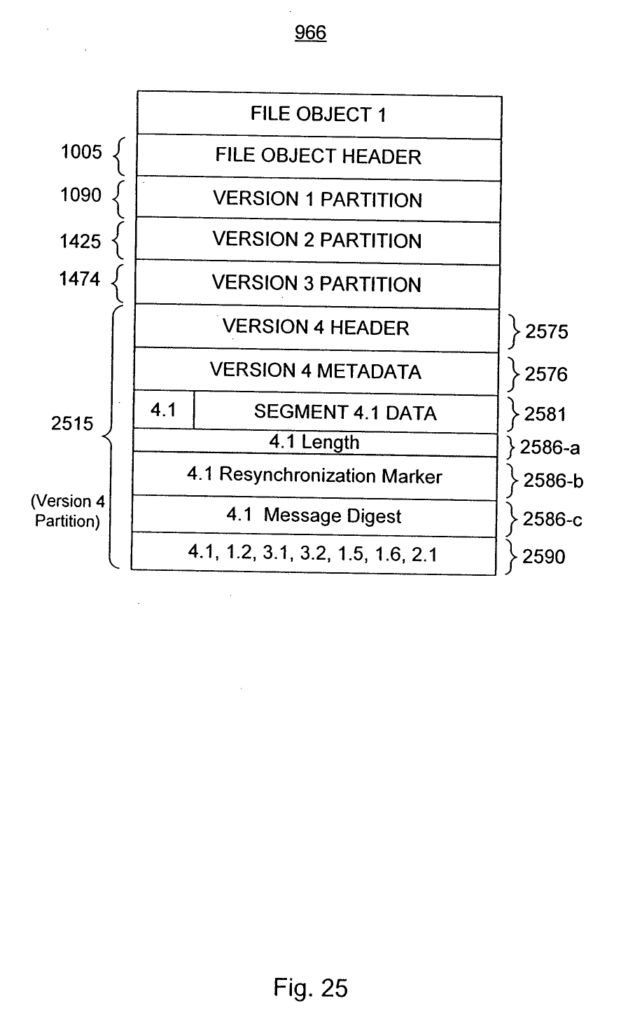

When the server module 435 receives from the agent module 270 the data pertaining to the recent changes made to FILE 1, the server module 435 accesses the file object database 481 and determines that the file object 966 corresponding to FILE 1 already exists. The server module 435 further examines the file object 966 and determines that it already includes file object header 1005, version 1 partition 1090, version 2 partition 1425, and version 3 partition 1474. The server module 435 accordingly updates the file object header 1005 as necessary, and creates a new version partition to store the data pertaining to the most recent changes to FILE 1. FIG. 25 shows an updated file object 966 containing a new version partition 2515 (the “version 4 partition”), which comprises version 4 header 2575 and version 4 metadata 2576. Field 2581 stores a copy of the new segment 4.1, and the segment label “4.1.” Fields 2586-a, 2586-b and 2586-c comprise, respectively, segment length information for file segment 4.1, the resynchronization marker for segment 4.1 and the message digest corresponding to the file segment 4.1. Field 2590 holds a version descriptor listing the segments that make up the fourth version. In this instance, the version descriptor field 2590 comprises “4.1, 1.2, 3.1, 3.2, 1.5, 1.6, 2.1.”

Subsequent Backup: Example IV: Data Changed at Beginning of File and in Middle of File

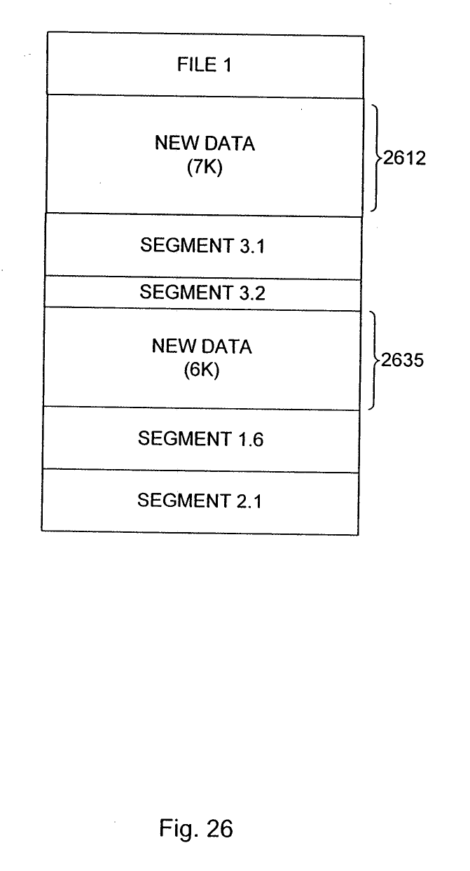

In accordance with an embodiment of the invention, the techniques described in FIGS. 16 and 22 may be used together to identify previously-defined file segments within a file. By way of example, suppose that the user edits FILE 1 by replacing file segments 4.1 and 1.2 with a first block of new data, and by replacing file segment 1.5 with a second block of new data. FIG. 26 shows an revised version of FILE 1 comprising new data block 2612 at the beginning of the file (in place of previously-defined file segments 4.1 and 1.2) and new data block 2635 in place of previously-defined file segment 1.5. In this example, new data block 2612 comprises seven kilobytes (7K) of data, and thus is significantly larger than a standard-length data block. Similarly, new data block 2635 comprises six kilobytes (6K) of data.

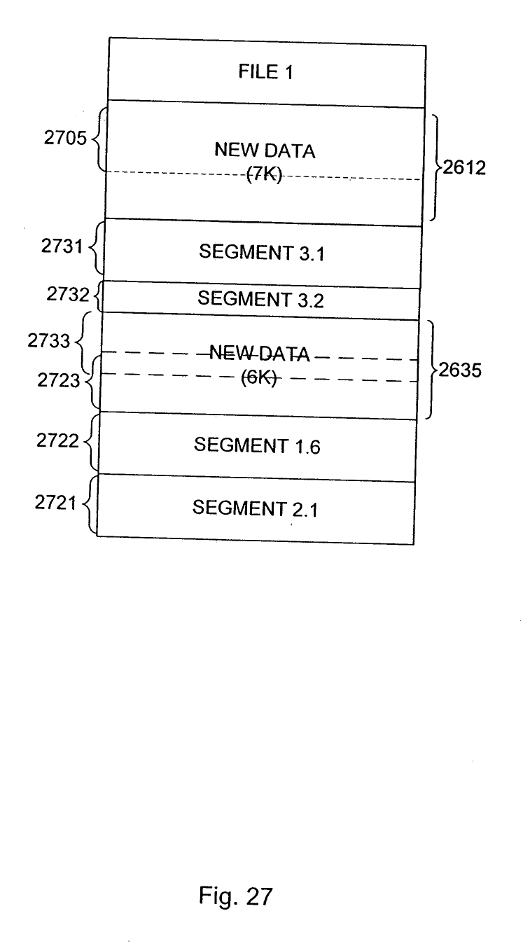

When the agent module 270 next backs up FILE 1, the agent module 270 performs the steps outlined in FIG. 12A. The agent module 270 retrieves FILE 1 from storage (step 1210) and retrieves segment length information for a selected segment from the current version database 260 (shown in FIG. 24). In this instance, the agent module 270 retrieves from field 831-a the segment length information pertaining to previously-defined file segment 4.1. At step 1230, the agent module 270 defines a candidate file segment (starting from the beginning of the file) based on the retrieved segment length information. FIG. 27 shows a candidate file segment 2705 defined within FILE 1 based on the retrieved segment length information. Candidate file segment 2705 contains a portion of the new data block 2612. Consequently, when the agent module 270 computes a message digest based on the candidate data block (step 1240) and compares it to the message digest corresponding to previously-defined file segment 4.1 that is stored in the current version database 260 (step 1250), the message digests are not the same. As a result, in accordance with block 1265, the routine of FIG. 12A proceeds to step 1290 and the agent module 270 attempts an alternative method to identify previously-defined file segments.

In this example, the agent module first selects the technique outlined in FIG. 16. At step 1620, the agent module 270 retrieves segment length information for a selected file segment from the current version database 260, starting from the end of the current version database. Referring back to FIG. 24, the agent module 270 retrieves from field 1337-a the segment length information pertaining to previously-defined file segment 2.1. A candidate file segment is defined within FILE 1 based on the retrieved segment length information, starting from the end of the file (step 1630). Referring again to FIG. 27, the agent module 270 defines candidate file segment 2721. At step 1640, a message digest is computed based on the candidate file segment 2721, and at step 1650 the computed message digest is compared to the message digest that corresponds to previously-defined file segment 2.1 (stored in field 1337-c of the current version database 260). In this example, the two message digests are the same and the agent module therefore concludes that the previously-defined file segment 2.1 has not been changed. Working from the end of the current version database 260 toward the beginning of the database, and from the beginning of FILE 1 toward the beginning of the file, the agent module repeats the procedure outlined in FIG. 16. The segment length information pertaining to previously-defined file segment 1.6 is retrieved from the current version database 260, a candidate file segment 2722 is defined within FILE 1 (as shown in FIG. 27), a message digest is computed from the candidate file segment and compared to the stored message digest corresponding to previously-defined file segment 1.6. Again, the computed message digest and the stored message digest are the same, and the agent module 270 concludes that the previously-defined file segment 1.6 has not been changed.

The agent module 270 next retrieves the segment length information pertaining to the previously-defined file segment 1.5 (from field 835-a of the current version database 260). A candidate file segment 2723 is defined within FILE 1, as shown in FIG. 27. Because the user deleted file segment 1.5 and replaced it with the new data block 2635, the candidate file segment 2723 comprises a portion of the new data block 2635. Consequently, when a message digest is computed based on the candidate file segment 2723 and compared to the message digest that corresponds to the previously-defined file segment 1.5 (stored in field 835-c of the current version database 260), the message digests do not match. The agent module 270 thus concludes that the candidate file segment 2723 is not the same as the previously-defined file segment 1.5. In this example, the agent module 270 now attempts to use the resynchronization markers stored in the current version database 260 to identify previously-defined file segments, in accordance with the method described in FIG. 22.

The resynchronization marker corresponding to previously-defined file segment 4.1 is retrieved from field 831-b of the current version database 260 (step 2222). The agent module 270 searches within FILE 1 for a data block matching the retrieved resynchronization marker. Because the user deleted segment 4.1, no matching data block is found. The agent module 270 repeats the procedure using the resynchronization marker corresponding to previously-defined file segment 1.2, but again does not find a matching data block in FILE 1 (because the user also deleted file segment 1.2).

The agent module 270 next retrieves the resynchronization marker corresponding to previously-defined file segment 3.1 from field 833-b of the current version database 260, and searches within FILE 1 for a matching data block. In this example, a matching data block is found. The segment length information for file segment 3.1 is retrieved from the current version database 260 (step 2237), and a candidate file segment is defined within FILE 1 based on the location of the resynchronization marker within the file and the segment length information (step 2239). Referring to FIG. 27, the agent module defines candidate file segment 2731 based on the location of the segment 3.1 resynchronization marker within the file and the segment 3.1 length information. A message digest is computed based on the candidate file segment 2731 (step 2242), and compared to the message digest stored in field 833-c of the current version database 260 (which corresponds to previously-defined file segment 3.1). In this example, the computed digest is the same as the stored digest; consequently the agent module 270 concludes that the candidate segment 2731 is the same as the previously-defined file segment 3.1 (step 2255). The agent module 270 also concludes that the new data block 2612 (at the beginning of FILE 1) does not correspond to any previously-defined file segment.

Referring to FIG. 22, the routine now proceeds to block 1275 of FIG. 12A. Following the routine described in FIG. 12A, the agent module 270 next retrieves from the current version database 260 the segment length information pertaining to previously-defined file segment 3.2, and defines a candidate file segment 2732 based on such information. A message digest is computed based on the candidate segment 2732, and compared to the stored message digest that corresponds to the previously-defined file segment 3.2 (in field 834-c). In this example, the message digests are the same, and the agent module 270 concludes that the previously-defined file segment 3.2 has not been changed.

The agent module now retrieves the segment length information pertaining to the previously-defined file segment 1.5 (from field 835-a of the current version database 260), and uses this information to define a candidate file segment within FILE 1. FIG. 27 shows a candidate file segment 2733 that is defined based on the file segment 1.5 length information. Candidate file segment 2733 contains a portion of the new data block 2635, which was inserted by the user in place of file segment 1.5. Consequently, when a message digest is computed based on the candidate file segment 2733 and compared to the message digest stored in the current version database 260 that corresponds to the previously-defined file segment 1.5, the message digests do not match. The agent module 270 thus concludes that the new data block 2635 does not correspond to any previously-defined file segment(s).

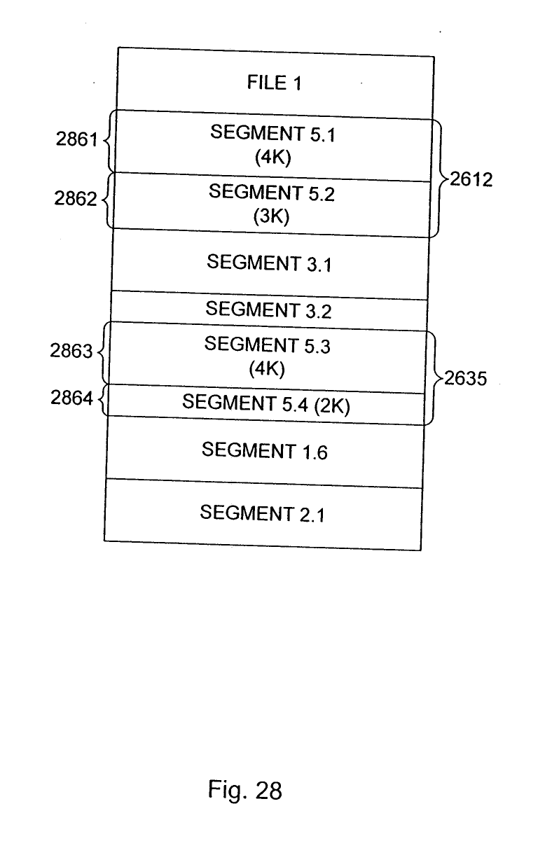

Having determined that new data blocks 2612 and 2635 do not correspond to any previously-defined file segment(s), the agent module 270 divides each of the data blocks 2612 and 2635 into one or more file segments. In this example, each of the new data blocks is divided into two file segments. FIG. 28 shows an updated version of FILE 1 in which two new file segments 2861 and 2862 are defined within new data block 2612, and two new file segments 2863 and 2864 are defined within new data block 2635. It should be noted that in alternative examples, a data block may be divided into any number of file segments.

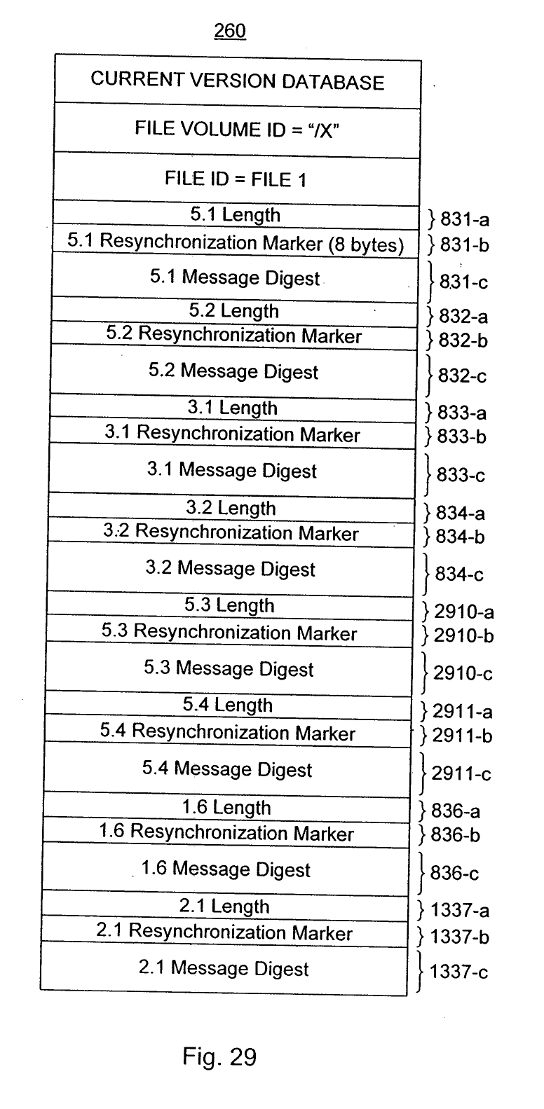

The agent module 270 now updates the current version database 260. The agent module 270 stores in the current version database 260 segment length information, message digests and resynchronization markers corresponding to the new file segments 2861-2864 of FILE 1. The new file segments are assigned segment labels. Because this is the fifth time that FILE 1 is being backed up, the version is designated “5.” Because four segments within FILE 1 are different from the previous version, the new segments are assigned the segment labels “5.1,” “5.2,” “5.3,” and “5.4,” as shown in FIG. 28. Referring now to FIG. 29, the agent module 270 stores segment length information, resynchronization markers, and message digests corresponding to file segments 5.1-5.4 in the current version database 260. In this example, records 831, 832, 2910 and 2911 store the resynchronization markers and message digests for file segments 5.1, 5.2, 5.3, and 5.4, respectively. The information pertaining to file segments 4.1, 1.2, and 1.5 is no longer stored in the current version database 260.

The agent module 270 transmits to the server module 435 data identifying client 110, folder 215, and FILE 1, copies of the new file segments 5.1-5.4, copies of the message digests corresponding to new file segments 5.1-5.4, and the resynchronization markers corresponding to file segments 5.1-5.4. The agent module 270 may additionally transmit to the server module 435 additional information including a version descriptor, date/time information, etc.

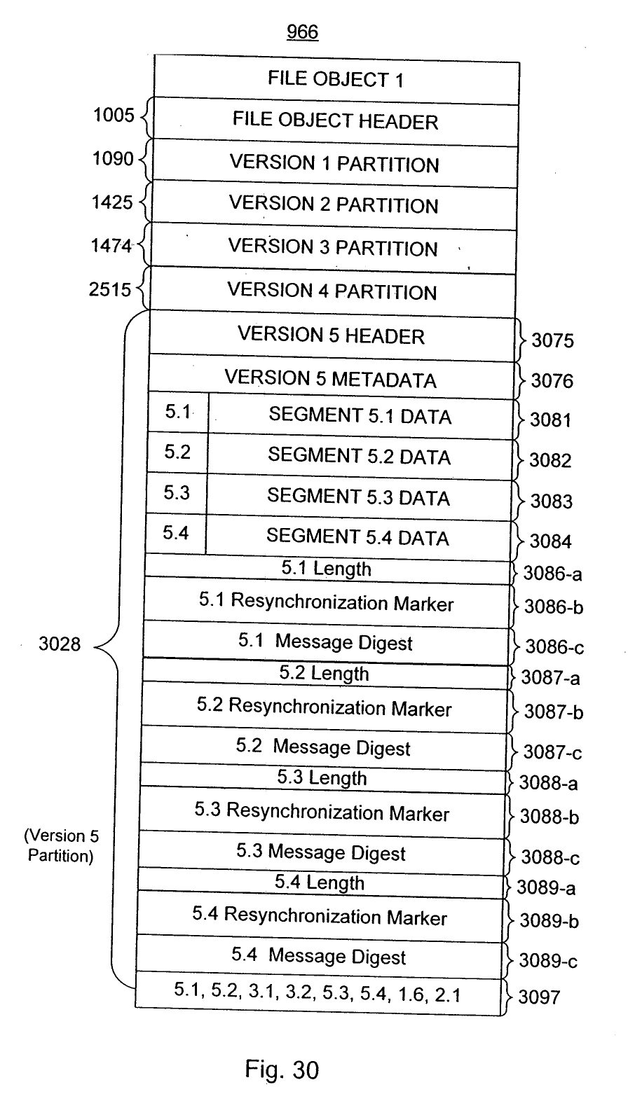

When the server module 435 receives from the agent module 270 the data pertaining to the recent changes made to FILE 1, the server module 435 accesses the file object database 481 and determines that the file object 966 corresponding to FILE 1 already exists. The server module 435 further examines the file object 966 and determines that it already includes file object header 1005, version 1 partition 1090, version 2 partition 1425, version 3 partition 1474 and version 4 partition 2515. The server module 435 accordingly updates the file object header 1005 as necessary, and creates a new version partition to store the data pertaining to the most recent changes to FILE 1. FIG. 30 shows an updated file object 966 to which a new version partition 3028 (the “version 5 partition”) has been added. The version 5 partition 3028 comprises a version 5 header 3075 and version 5 metadata 3076. Fields 3081-3084 store copies of the new segments 5.1-5.4, respectively, and the corresponding segment labels. Records 3086-3089 comprise segment length information, resynchronization markers and message digests corresponding to the file segments 5.1-5.4, respectively. Field 3097 holds a version descriptor listing the segments that make up the fifth version. In this instance, the version descriptor field 3097 comprises “5.1, 5.2, 3.1, 3.2, 5.3, 5.4, 1.6, 2.1.”

It should be noted that the alternative methods described in FIGS. 12A, 16, and 22 may be used either independently to identify previously-defined file segments in a file, or they may be used together. When used together, they may be used in any order. Additional combinations not described here are possible. For example, the agent module 270 may first search for previously-defined file segments using the resynchronization markers stored in the current version database 260, as described in FIG. 22. Then, if any portions of the file are unaccounted for, the agent module 270 may attempt to identify previously-defined segments by defining candidate file segments starting from the end of a file, as outlined in FIG. 16. If there is still a portion of the file for which no previously-defined file segment has been identified, the agent module 270 may then follow the procedure shown in FIG. 12A with respect to the remaining portion of the file (starting from the beginning and moving toward the end of the file). In addition, information concerning the size of an altered file may be analyzed and used to determine which of the above techniques should be used (and in which order), and the scope of any search performed within the file, to maximize the probability of identifying previously-defined file segments.

Restore Function

From time to time, a user may wish to restore data from the storage device 155 in the backup server 140 to a local storage device. For example, if the storage device 111 within the client 110 becomes corrupted, a user at the client 110 may wish to recover one or more data files that have been backed up on the storage device 155.

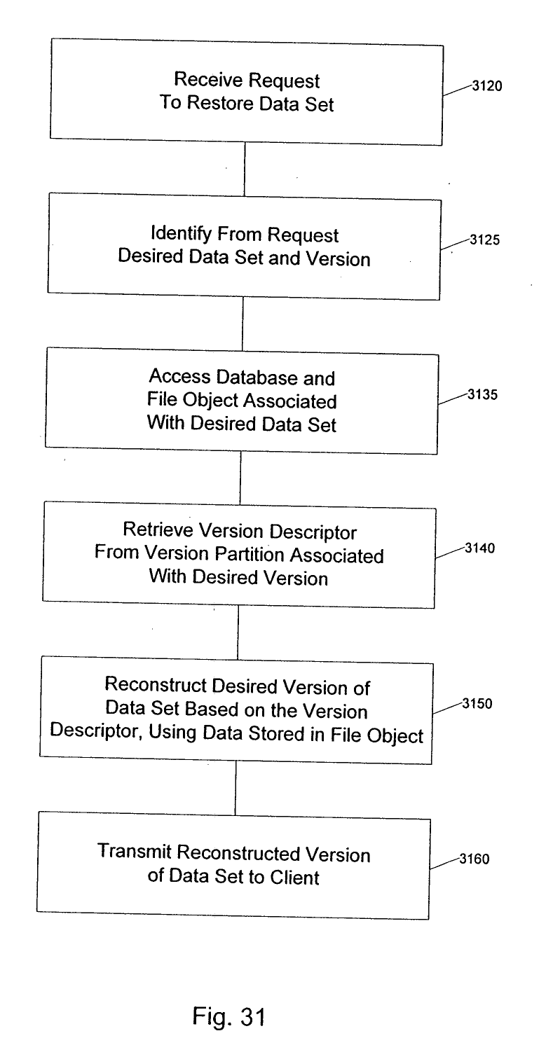

FIG. 31 is a flowchart of an example of a method to restore data that has been backed up, in accordance with an embodiment of the invention. When the agent module 270 receives a request from a user to restore a selected data set, the agent module 270 transmits the request to the server module 435. The request may specify a version of the data set. At step 3120, the server module 435 receives the request, and at step 3125 the server module 435 identifies from the request the desired data set and version number; if the desired version is not specified, the server module 435 concludes that the most recent version of the data set is desired. At step 3135, the server module 435 accesses the file object database and the specific data object therein that is associated with the requested data set. At step 3140, the server module 435 retrieves the version descriptor from the version partition within the data object that is associated with the desired version. The version descriptor specifies the segments that make up the desired version. At step 3150, the server module 435 reconstructs the desired version of the data set from the data stored in the object database, based on the retrieved version descriptor. At step 3160, the server module 435 transmits the reconstructed version of the data set to the agent module 270 in the client 110, which then stores the reconstructed data set in local storage.

For example, a user at the client 110 may determine that the data in the local storage device 111 has been corrupted, and make a request to the agent module 270, via an appropriate GUI, to restore FILE 1. The user in this example does not specify a version number. The agent module 270 transmits the request to the server module 435, which receives the request and determines that the user wishes to restore FILE 1. Because the user did not specify a version number, the server module 435 concludes that the most recent version of FILE 1 is desired. The server module 435 accesses the file object database 481, and more particularly accesses file object 966 (shown in FIG. 30) which stores data pertaining to FILE 1.

The server module 435 reconstructs the most recent version of FILE 1 from the data stored in the file object 966. The server module 435 examines the most recent version partition, which in this instance is the version 5 partition 3028. The server module 435 retrieves the version descriptor from field 3097 within the version 5 partition. This most recent version descriptor informs the server module 435 which file segments need to be retrieved to reconstruct the most recent version of FILE 1. In this example, the version descriptor comprises “5.1, 5.2, 3.1, 3.2, 5.3, 5.4, 1.6, 2.1.”

Accordingly, the server module 435 retrieves the file segments 5.1 and 5.2 from the appropriate fields of the version 5 partition 3028, file segments 3.1 and 3.2 from the appropriate field of the version 3 partition 1474, file segments 5.3 and 5.4 from the appropriate fields of the version 5 partition 3028, file segment 1.6 from the appropriate field of the version 1 partition 1090, and file segment 2.1 from the appropriate field of the version 2 partition 1425. The server module 435 then reconstructs the most recent version (version 5) of FILE 1.

The server module 435 transmits the reconstructed FILE 1 to the agent module 270. When the agent module 270 receives the reconstructed FILE 1, the agent module 270 stores the file in the storage device 111, and informs the user that FILE 1 has been restored.

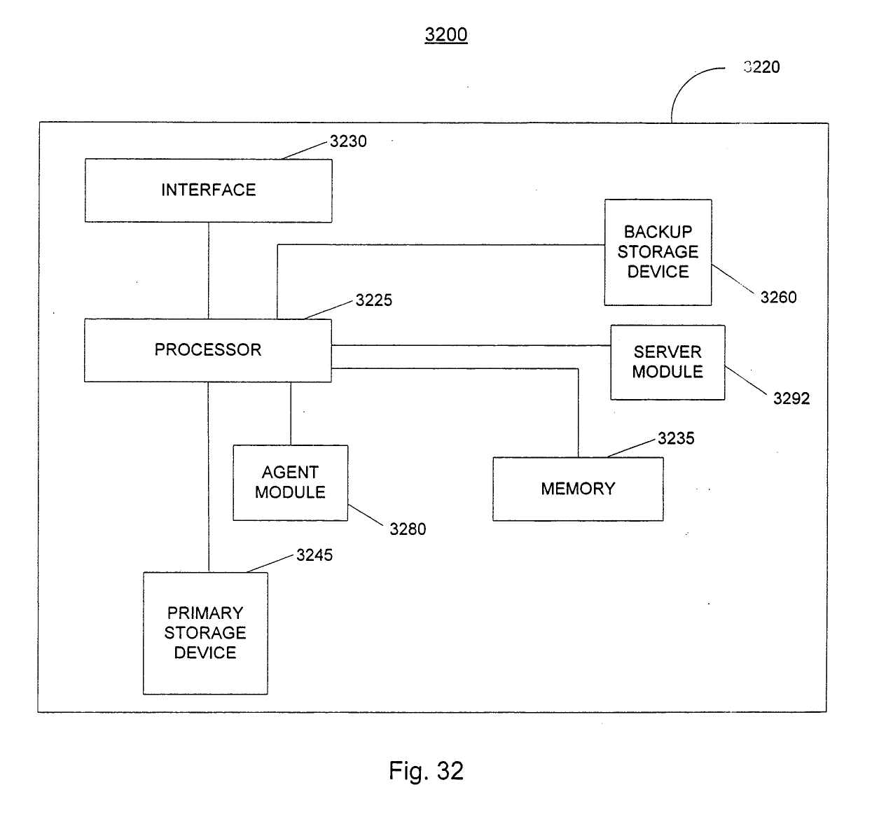

The methods described above are not limited to the system of FIG. 1 but may be used to back up data in a variety of different systems. For example, FIG. 32 is a block diagram of an example of another system 3200 that may be used to store data, in accordance with an embodiment of the invention. The system 3200 comprises a device 3220, which may be a personal computer, for example. The device 3220 comprises a processor 3225, an interface 3230, a memory 3235, a primary storage device 3245, and a backup storage device 3260. The device 3220 also comprises an agent module 3280 and a server module 3292. The agent module 3280 and the server module 3292 both reside and operate on the same device 3220. The agent module 3280 functions in a manner similar to that of the agent module 270 of FIG. 2. The server module 3292 functions in a manner similar to that of the server module 435 of FIG. 4. In this example, the agent module 3280 retrieves data stored in the primary storage device 3245 and sends the data to the server module 3292 for the purpose of backing up the data. The agent module 3280 may maintain a current version database in the primary storage device 3245, in the manner described above. The server module 3292 receives the data and stores the data in the backup storage device 3260. The server module 3292 may maintain one or more databases in the backup storage device 3260 for the purpose of storing the data received from the agent module 3280. In another alternative example, the primary storage device 3245 and the backup storage device 3260 may be the same.

The foregoing merely illustrates the principles of the invention. It will thus be appreciated that those skilled in the art will be able to devise numerous other arrangements which embody the principles of the invention and are thus within its spirit and scope. For example, the system 100, the client 110 and the backup server 140 are disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

1. A method of backing up data, comprising:
storing a data set in a database, at a first moment in time;
defining at least first and second segments of data within the data set;
storing, in association with the database, a portion of a selected one of the at least two segments; and
identifying a location of a third segment of data within the data set, at a second moment in time subsequent to the first moment, based, at least in part, on the portion.

2. The method of claim 1, further comprising:
determining whether the selected segment has been altered between the first and second moments in time.

3. The method of claim 2, further comprising:
generating a digest representing the selected segment; and
storing the digest in association with the portion.

4. The method of claim 3, comprising:
determining whether the selected segment has been altered by:
generating a second digest representing the third segment;
comparing the second digest to the stored digest; and
determining that the selected segment has been altered, if the second digest and the stored digest are not the same.

5. The method of claim 4, wherein the portion comprises a predetermined quantity of data selected from a corresponding segment.

6. The method of claim 5, wherein the portion comprises eight bytes of data selected from the corresponding segment.

7. The method of claim 6, wherein the eight bytes are selected from a beginning of the corresponding segment.

8. The method of claim 1, wherein the digest comprises a hash value.

9. The method of claim 8, wherein the hash value is generated using a message digest 5 algorithm.

10. The method of claim 8, wherein the hash value is generated using a secure hash algorithm.

11. The method of claim 4, further comprising:
storing, in the database, a second portion retrieved from the third segment and a digest representing the third segment; if the selected segment has been altered.

12. The method of claim 11, further comprising: storing, in a second database, the second portion of the third segment and the second digest representing the third segment; if the selected segment has been altered.

13. The method of claim 12, further comprising:
storing, in the second database, an identifier of the third segment.

14. The method of claim 13, comprising:
identifying the location of the third segment within the data set, at the second moment in time subsequent to the first moment, by:
searching within the data set for the portion, starting at a beginning of the data set.

15. The method of claim 13, comprising:
identifying the location of the third segment within the data set, at the second moment in time subsequent to the first moment, by:
searching within the data set for the portion, starting at an end of the data set.

16. The method of claim 1, comprising:
identifying the location of the third segment within the data set, at the second moment in time subsequent to the first moment, by:
searching within the data set for the portion, starting at a beginning of the data set.

17. The method of claim 1, comprising:
identifying the location of the third segment within the data set, at the second moment in time subsequent to the first moment, by:
searching within the data set for the portion, starting at an end of the data set.

18. A method for backing up data, comprising:
storing a data set in a database, at a first moment in time;
defining at least two segments of data in the data set;
storing, in association with the first database, at least one digest representing a selected one of the at least two segments;
retrieving, at a second moment in time subsequent to the first moment in time, the at least one digest; and
determining whether a the selected segment has been altered since the first moment in time, based at least in part on the retrieved digest.

19. The method of claim 18, wherein the digest comprises a hash value.

20. The method of claim 19, wherein the hash value is generated using a message digest 5 algorithm.

21. The method of claim 19, wherein the hash value is generated using a secure hash algorithm.

22. The method of claim 19, comprising:
determining whether the selected segment has been altered since the first moment in time by:
identifying a second segment from the data set;
generating a second digest based on the second segment;
comparing the second digest to the first digest; and
determining that the selected segment has been altered, if the second digest and the first digest are not the same.

23. The method of claim 22, wherein the second digest comprises a second hash value.

24. The method of claim 23, wherein the second hash value is generated using a message digest 5 algorithm.

25. The method of claim 23, wherein the second hash value is generated using a secure hash algorithm.

26. The method of claim 22, further comprising:
storing the selected segment in a second database.

27. The method of claim 26, further comprising:
storing the second segment in the second database, if the selected segment has been altered.

28. The method of claim 27, comprising:
storing the selected segment in a first location in the second database; and
storing the second segment in a second location in the second database.

29. The method of claim 27, further comprising:
storing, in association with the first database, a portion representing a third segment selected from among the at least two segments; and
identifying a location of a fourth segment within the data set, at a third moment in time subsequent to the first moment in time, based on the portion.

30. The method of claim 29, comprising:
identifying the location of the fourth segment within the data set, at the third moment in time subsequent to the first moment in time, by:
searching within the data set for the portion, starting at a beginning of the data set.

31. The method of claim 29, comprising:
identifying the location of the fourth segment within the data set, at the third moment in time subsequent to the first moment in time, by:
searching within the data set for the portion, starting at an end of the data set.

32. The method of claim 29, wherein the portion comprises a predetermined quantity of data selected from a the third segment.

33. The method of claim 32, wherein the portion comprises eight bytes of data selected from the third segment.

34. The method of claim 33, wherein the eight bytes of data are selected from a beginning of the third segment.

35. A method for storing data, comprising:
storing a first version of a data file in a first database and in a second database;
defining at least two first segments within the first version;
storing a second version of the data file in the first database;
determining whether the second version contains all of the at least two first segments;
defining one or more second segments within the second version different from any of the at least two first segments, if the second version does not contain all of the at least two first segments; and
storing the one or more second segments in the second database.

36. The method of claim 35, further comprising:
defining one or more additional segments within the second version, if the second version does contain all of the at least two first segments; and
storing the one or more additional segments in the second database.

37. The method of claim 35, further comprising:
storing, in association with the first database, digests representing the respective first segments; and
determining whether the second version contains all of the at least two first segments, based, at least in part, on the digests.

38. The method of claim 37, further comprising:
storing, in association with the first database, portions of respective first segments; and
defining the one or more second segments within the second version, based, at least in part, on the portions.

39. The method of claim 38, further comprising:
storing, in association with the first database, digests representing the one or more second segments.

40. The method of claim 39, wherein the digests comprise hash values.

41. The method of claim 40, wherein the hash values are generated using a message digest 5 algorithm.

42. The method of claim 40, wherein the hash values are generated using a secure hash algorithm.

43. The method of claim 40, wherein the at least one portion comprises a predetermined quantity of data selected from a corresponding first segment.

44. The method of claim 43, wherein the at least one portion comprises eight bytes of data selected from the corresponding segment.

45. The method of claim 44, wherein the eight bytes of data are selected from a beginning of the corresponding segment.

46. A system to back up data, comprising:
a memory configured to:
store a database comprising one or more data sets; and
a processor configured to:
store a data set in the database, at a first moment in time;
define at least first and second segments of data within the data set;
store, in association with the database, a portion of a selected one of the at least two segments; and
identify a location of a third segment of data within the data set, at a second moment in time subsequent to the first moment, based, at least in part, on the portion.

47. The system of claim 46, wherein the processor is further configured to:
determine whether the selected segment has been altered between the first and second moments in time.

48. The system of claim 47, wherein the processor is further configured to:
generate a digest representing the selected segment; and
store the digest in association with the portion.

49. The system of claim 48, wherein the processor is further configured to:
determine whether the selected segment has been altered by:
generating a second digest representing the third segment;
comparing the second digest to the stored digest; and
determining that the selected segment has been altered, if the second digest and the stored digest are not the same.

50. The system of claim 49, wherein the portion comprises a predetermined quantity of data selected from a corresponding segment.

51. The system of claim 50, wherein the portion comprises eight bytes of data selected from the corresponding segment.

52. The system of claim 51, wherein the eight bytes are selected from a beginning of the corresponding segment.

53. The system of claim 46, wherein the digest comprises a hash value.

54. The system of claim 53, wherein the processor is further configured to:
generate the hash value using a message digest 5 algorithm.

55. The system of claim 53, wherein the processor is further configured to:
generate the hash value using a secure hash algorithm.

56. The system of claim 49, wherein the processor is further configured to:
store, in the database, a second portion retrieved from the third segment and a digest representing the third segment; if the selected segment has been altered.

57. The system of claim 56, further comprising:
a second processor configured to:
store, in a second database, the second portion of the third segment and the second digest representing the third segment; if the selected segment has been altered.

58. The system of claim 57, wherein the second processor is further configured to:
store, in the second database, an identifier of the third segment.

59. The system of claim 58, wherein the processor is further configured to:
identify the location of the third segment within the data set, at the second moment in time subsequent to the first moment, by searching within the data set for the portion, starting at a beginning of the data set.

60. The system of claim 58, wherein the processor is further configured to:
identify the location of the third segment within the data set, at the second moment in time subsequent to the first moment, by searching within the data set for the portion, starting at an end of the data set.

61. The system of claim 46, wherein the processor is further configured to:
identify the location of the third segment within the data set, at the second moment in time subsequent to the first moment, by searching within the data set for the portion, starting at a beginning of the data set.

62. The system of claim 46, wherein the processor is further configured to:
identify the location of the third segment within the data set, at the second moment in time subsequent to the first moment, by searching within the data set for the portion, starting at an end of the data set.

63. A system to back up data, comprising:
a memory configured to:
store a database comprising one or more data sets; and
a processor configured to:
store a data set in the database, at a first moment in time;
define at least two segments of data in the data set;
store, in association with the first database, at least one digest representing a selected one of the at least two segments;
retrieve, at a second moment in time subsequent to the first moment in time, the at least one digest; and
determine whether a the selected segment has been altered since the first moment in time, based at least in part on the retrieved digest.

64. The system of claim 63, wherein the digest comprises a hash value.

65. The system of claim 64, wherein the processor is configured to:
generate the hash value using a message digest 5 algorithm.

66. The system of claim 64, wherein the processor is further configured to:
generate the hash value using a secure hash algorithm.

67. The system of claim 64, wherein the processor is further configured to:
determine whether the selected segment has been altered since the first moment in time by:
identifying a second segment from the data set;
generating a second digest based on the second segment;
comparing the second digest to the first digest; and
determining that the selected segment has been altered, if the second digest and the first digest are not the same.

68. The system of claim 67, wherein the second digest comprises a second hash value.

69. The system of claim 68, wherein the processor is further configured to:
generate the second hash value using a message digest 5 algorithm.

70. The system of claim 68, wherein the processor is further configured to:
generate the second hash value using a secure hash algorithm.

71. The system of claim 67, further comprising a second processor configured to:
store the selected segment in a second database.

72. The system of claim 71, wherein the second processor is further configured to:
store the second segment in the second database, if the selected segment has been altered.

73. The system of claim 72, wherein the second processor is further configured to:
store the selected segment in a first location in the second database; and
store the second segment in a second location in the second database.

74. The system of claim 72, wherein the processor is further configured to:
store, in association with the first database, a portion representing a third segment selected from among the at least two segments; and
identify a location of a fourth segment within the data set, at a third moment in time subsequent to the first moment in time, based on the portion.

75. The system of claim 74, wherein the processor is further configured to:
identify the location of the fourth segment within the data set, at the third moment in time subsequent to the first moment in time, by searching within the data set for the portion, starting at a beginning of the data set.

76. The system of claim 74, wherein the processor is further configured to:
identify the location of the fourth segment within the data set, at the third moment in time subsequent to the first moment in time, by searching within the data set for the portion, starting at an end of the data set.

77. The system of claim 74, wherein the portion comprises a predetermined quantity of data selected from a the third segment.

78. The system of claim 77, wherein the portion comprises eight bytes of data selected from the third segment.

79. The system of claim 78, wherein the eight bytes of data are selected from a beginning of the third segment.

80. A system to store data, comprising:
a memory configured to:
store a database comprising one or more data sets;
a first processor configured to:
store a first version of a data file in a first database; and
a second processor configured to:
store the first version of the data set in a second database;
wherein the first processor is further configured to:
define at least two first segments within the first version;
store a second version of the data file in the first database;
determine whether the second version contains all of the at least two first segments; and
define one or more second segments within the second version different from any of the at least two first segments, if the second version does not contain all of the at least two first segments; and
wherein the second processor is further configured to:
store the one or more second segments in the second database.

81. The system of claim 80, wherein the first processor is further configured to:
define one or more additional segments within the second version, if the second version does contain all of the at least two first segments; and
wherein the second processor is further configured to:
store the one or more additional segments in the second database.

82. The system of claim 80, wherein the first processor is further configured to:
store, in association with the first database, digests representing the respective first segments; and
determine whether the second version contains all of the at least two first segments, based, at least in part, on the digests.

83. The system of claim 82, wherein the first processor is further configured to:
store, in association with the first database, portions of respective first segments; and
define the one or more second segments within the second version, based, at least in part, on the portions.

84. The system of claim 83, wherein the first processor is further configured to:
store, in association with the first database, digests representing the one or more second segments.

85. The system of claim 84, wherein the digests comprise hash values.

86. The system of claim 85, wherein the first processor is further configured to:
generate the hash values using a message digest 5 algorithm.

87. The system of claim 85, wherein the first processor is further configured to:
generate the hash values using a secure hash algorithm.

88. The system of claim 85, wherein the at least one portion comprises a predetermined quantity of data selected from a corresponding first segment.

89. The system of claim 88, wherein the at least one portion comprises eight bytes of data selected from the corresponding segment.

90. The system of claim 89, wherein the eight bytes of data are selected from a beginning of the corresponding segment.
